(19) United States
(12) Patent Application Publication
(10) Pub. No.: US 2021/0314995 A1
(43) Pub. Date: Oct. 7, 2021

(54) METHOD FOR TRANSMITTING OR RECEIVING MPDCCH IN WIRELESS COMMUNICATION SYSTEM SUPPORTING MTC, AND APPARATUS THEREFOR

(71) Applicant: LG ELECTRONICS INC., Seoul (KR)

(72) Inventors: Jaehyung Kim, Seoul (KR); Seonwook Kim, Seoul (KR); Changhwan Park, Seoul (KR); Seokmin Shin, Seoul (KR); Joonkui Ahn, Seoul (KR); Suckchel Yang, Seoul (KR); Seunggye Hwang, Seoul (KR)

(21) Appl. No.: 17/266,462

(22) PCT Filed: Aug. 8, 2019
(86) PCT No.: PCT/KR2019/009985

§ 371 Date: Feb. 5, 2021

Related U.S. Application Data
(60) Provisional application No. 62/716,974, filed on Aug. 9, 2018.
(60) Provisional application No. 62/720,090, filed on Aug. 20, 2018.
(60) Provisional application No. 62/755,367, filed on Nov. 2, 2018.

(30) Foreign Application Priority Data
Sep. 20, 2018 (KR) 10-2018-0113322
Oct. 9, 2018 (KR) 10-2018-0120121
Feb. 15, 2019 (KR) 10-2019-0018225
Mar. 28, 2019 (KR) 10-2019-0036409

(51) Int. Cl. H04W 72/12; H04W 72/04; H04W 4/70

(52) U.S. Cl. CPC H04W 72/1289; H04W 72/0446; H04W 4/70; H04W 72/0453; H04W 72/1273

(57) ABSTRACT

The present specification provides a method for transmitting an MPDCCH in a wireless communication system supporting MTC. More specifically, the method performed by a base station comprises the steps of: mapping an MPDCCH to resource elements (REs); and transmitting the MPDCCH on the REs to a terminal, wherein the mapping of the MPDCCH comprises a step of copying REs used for the MPDCCH in at least one symbol of a second slot of a subframe onto at least one symbol of a first slot of the subframe.

### TECHNICAL FIELD

The present disclosure relates to a wireless communication system supporting Machine Type Communication (MTC), and more particularly, to a method for transmitting and receiving an MTC Physical Downlink Control Channel (MPDCCH) and an apparatus for supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An object of the present disclosure is to provide a method for supporting standalone operation of LTE-MTC.

In addition, an object of the present disclosure is to provide a performance improvement of standalone MTC (sMTC) by copying MPDCCH REs to an LTE control region.

The technical objects to attain in the present disclosure are not limited to the above-described technical objects and other technical objects which are not described herein will become apparent to those skilled in the art from the following description.

### Technical Solution

In the present disclosure, a method of transmitting an PDCCH in a wireless communication system supporting MTC, performed by a base station, includes mapping an MPDCCH to resource elements (REs); and transmitting the MPDCCH on the REs to a terminal, where the mapping of the MPDCCH includes a step of copying REs used for the MPDCCH in at least one symbol of a second slot of a subframe to at least one symbol of a first slot of the subframe.

In addition, in the present disclosure, the at least one symbol of the first slot may a symbol corresponding to the at least one symbol of the second slot.

In addition, in the present disclosure, the at least one symbol of the second slot is a symbol including a Cell-specific Reference Signal (CRS).

In addition, in the present disclosure, wherein the at least one symbol of the first slot is included in a control region.

In addition, in the present disclosure, the control region is an LTE control region.

In addition, in the present disclosure, a number of the at least one symbol of the second slot is determined according to a number of symbols included in the control region.

In addition, in the present disclosure, the mapping of the MPDCCH is that coded bits are frequency first RE mapped in the at least one symbol of the second slot, and remaining bits of the coded bits are frequency first RE mapped in the at least one symbol of the first slot.

In addition, in the present disclosure, a base station for transmitting an MPDCCH in a wireless communication system supporting MTC, the base station includes a transmitter for transmitting a radio signal; a receiver for receiving a radio signal; at least one processor; and at least one computer memory operably connectable to the at least one processor and storing instructions that, when executed by the at least one processor, perform operations includes mapping an MPDCCH to resource elements (REs); and transmitting the MPDCCH on the REs to a terminal, where the mapping of the MPDCCH, includes a step of copying REs used for the MPDCCH in at least one symbol of a second slot of a subframe to at least one symbol of a first slot of the subframe.

### Technical Effects

The present disclosure has an effect of improving performance of standalone MTC (sMTC) by copying MPDCCH REs to the LTE control region.

The technical effects of the present disclosure are not limited to the technical effects described above, and other technical effects not mentioned herein may be understood to those skilled in the art from the description below.

### DESCRIPTION OF DRAWINGS

The accompanying drawings, which are included herein as a part of the description for help understanding the present disclosure, provide embodiments of the present disclosure, and describe the technical features of the present disclosure with the description below.

FIG. 1 is a diagram illustrating an example of the structure of a radio frame of LTE.

FIG. 2 is a diagram illustrating an example of a resource grid for downlink slot.

FIG. 3 illustrates an example of the structure of downlink subframe.

FIG. 4 illustrates an example of the structure of uplink subframe.

FIG. 5 illustrates an example of the frame structure type 1.

FIG. 6 is a diagram illustrating another example of the frame structure type 2.

FIG. 7 illustrates an example of the random access symbol group.

FIG. 8 is a diagram illustrating that 4 PBCH repetitions are applied in the conventional eMTC.

FIG. 9 illustrates an example of method of extending a PBCH to the LTE control region for an sMTC UE proposed in the present disclosure.

FIG. 10 illustrates an example of method of extending a PBCH to the LTE control region for an sMTC UE proposed in the present disclosure.

FIG. 11 illustrates an example of method of extending a PBCH to the LTE control region for an sMTC UE proposed in the present disclosure.

FIG. 12 is a flowchart illustrating an example of an operation method by a base station for transmitting an MPDCCH proposed in the present disclosure.

FIG. 13 is a flowchart illustrating an example of an operation method by a terminal for receiving an MPDCCH proposed in the present disclosure.

FIG. 14 illustrates a block diagram of a radio communication device to which methods suggested in the present disclosure may be applied.

FIG. 15 is another example of a block diagram of a radio communication device to which methods suggested in the present disclosure may be applied.

### BEST MODE FOR INVENTION

Some embodiments of the present disclosure are described in detail with reference to the accompanying drawings. A detailed description to be disclosed along with the accompanying drawings are intended to describe some exemplary embodiments of the present disclosure and are not intended to describe a sole embodiment of the present disclosure. The following detailed description includes more details in order to provide full understanding of the present disclosure. However, those skilled in the art will understand that the present disclosure may be implemented without such more details.

In some cases, in order to avoid that the concept of the present disclosure becomes vague, known structures and devices are omitted or may be shown in a block diagram form based on the core functions of each structure and device.

In this specification, a base station has the meaning of a terminal node of a network over which the base station directly communicates with a device. In this document, a specific operation that is described to be performed by a base station may be performed by an upper node of the base station according to circumstances. That is, it is evident that in a network including a plurality of network nodes including a base station, various operations performed for communication with a device may be performed by the base station or other network nodes other than the base station. The base station (BS) may be substituted with another term, such as a fixed station, a Node B, an eNB (evolved-NodeB), a Base Transceiver System (BTS), or an access point (AP). Furthermore, the device may be fixed or may have mobility and may be substituted with another term, such as User Equipment (UE), a Mobile Station (MS), a User Terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, or a Device-to-Device (D2D) device.

Hereinafter, downlink (DL) means communication from an eNB to UE, and uplink (UL) means communication from UE to an eNB. In DL, a transmitter may be part of an eNB, and a receiver may be part of UE. In UL, a transmitter may be part of UE, and a receiver may be part of an eNB.

Specific terms used in the following description have been provided to help understanding of the present disclosure, and the use of such specific terms may be changed in various forms without departing from the technical sprit of the present disclosure.

The following technologies may be used in a variety of wireless communication systems, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and Non-Orthogonal Multiple Access (NOMA). CDMA may be implemented using a radio technology, such as Universal Terrestrial Radio Access (UTRA) or CDMA2000. TDMA may be implemented using a radio technology, such as Global System for Mobile communications (GSM)/General Packet Radio Service (GPRS)/Enhanced Data rates for GSM Evolution (EDGE). OFDMA may be implemented using a radio technology, such as Institute of Electrical and Electronics Engineers (IEEE) 802.11 (Wi-Fi), IEEE 802.16 (WiMAX), IEEE 802.20, or Evolved UTRA (E-UTRA). UTRA is part of a Universal Mobile Telecommunications System (UMTS). 3rd Generation Partnership Project (3GPP) Long Term Evolution (LTE) is part of an Evolved UMTS (E-UMTS) using evolved UMTS Terrestrial Radio Access (E-UTRA), and it adopts OFDMA in downlink and adopts SC-FDMA in uplink. LTE-Advanced (LTE-A) is the evolution of 3GPP LTE.

Embodiments of the present disclosure may be supported by the standard documents disclosed in at least one of IEEE 802, 3GPP, and 3GPP2, that is, radio access systems. That is, steps or portions that belong to the embodiments of the present disclosure and that are not described in order to clearly expose the technical spirit of the present disclosure may be supported by the documents. Furthermore, all terms disclosed in this document may be described by the standard documents.

In order to more clarify a description, 3GPP LTE/LTE-A is chiefly described, but the technical characteristics of the present disclosure are not limited thereto.

General System

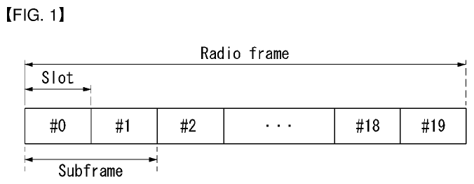

FIG. 1 is a diagram illustrating an example of the structure of a radio frame of LTE.

In FIG. 1 Error! Reference source not found. a radio frame includes 10 subframes. A subframe includes two slots in time domain. A time for transmitting one subframe is defined as a transmission time interval (TTI). For example, one subframe may have a length of 1 millisecond (ms), and one slot may have a length of 0.5 ms. One slot includes a plurality of orthogonal frequency division multiplexing (OFDM) symbols in time domain. Since the 3GPP LTE uses the OFDMA in the downlink, the OFDM symbol is for representing one symbol period. The OFDM symbol may also be referred to as an SC-FDMA symbol or a symbol period. A resource block (RB) is a resource allocation unit, and includes a plurality of contiguous subcarriers in one slot. The structure of the radio frame is shown for exemplary purposes only. Thus, the number of subframes included in the radio frame or the number of slots included in the subframe or the number of OFDM symbols included in the slot may be modified in various manners.

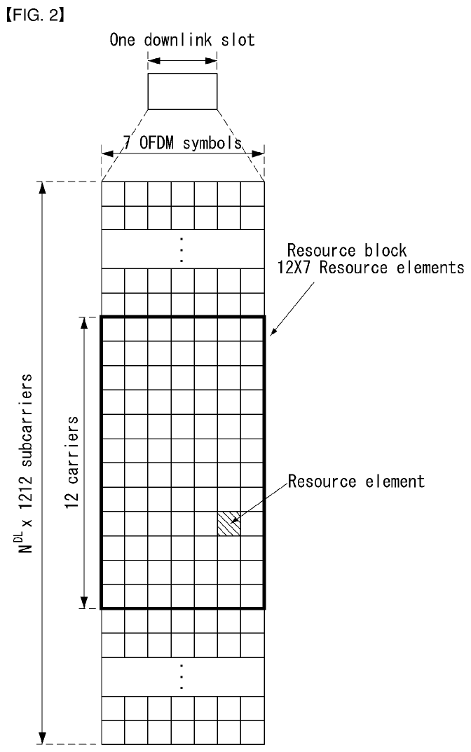

FIG. 2 is a diagram illustrating an example of a resource grid for downlink slot.

In FIG. 2, a downlink slot includes a plurality of OFDM symbols in time domain. It is described herein that one downlink slot includes 7 OFDM symbols, and one resource block (RB) includes 12 subcarriers in frequency domain as an example. However, the present disclosure is not limited thereto. Each element on the resource grid is referred to as a resource element (RE). One RB includes 12×7 REs. The number NDL of RBs included in the downlink slot depends on a downlink transmit bandwidth. The structure of an uplink slot may be same as that of the downlink slot.

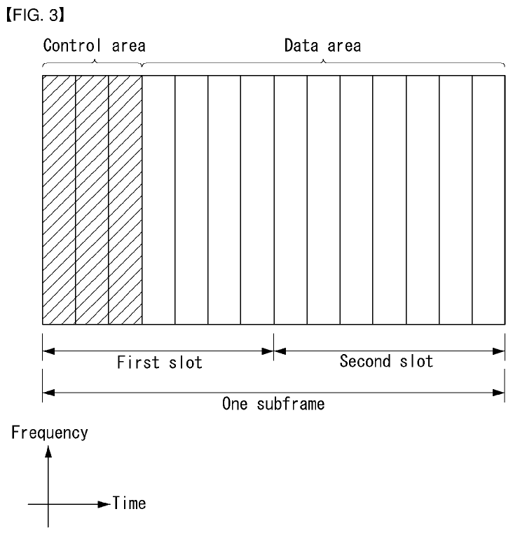

FIG. 3 illustrates an example of the structure of downlink subframe.

In FIG. 3, a maximum of three OFDM symbols located in a front portion of a first slot within a subframe correspond to a control region to be assigned with a control channel. The remaining OFDM symbols correspond to a data region to be assigned with a physical downlink shared chancel (PDSCH). Examples of downlink control channels used in the 3GPP LTE includes a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative-acknowledgment (NACK) signal. Control information transmitted through the PDCCH is referred to as downlink control information (DCI). The DCI includes uplink or downlink scheduling information or includes an uplink transmit (Tx) power control command for arbitrary UE groups.

The PDCCH may carry a transport format and a resource allocation of a downlink shared channel (DL-SCH), resource allocation information of an uplink shared channel (UL-SCH), paging information on a paging channel (PCH), system information on the DL-SCH, a resource allocation of an upper-layer control message such as a random access response transmitted on the PDSCH, a set of Tx power control commands on individual UEs within an arbitrary UE group, a Tx power control command, activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). A format of the PDCCH and the number of bits of the available PDCCH are determined according to a correlation between the number of CCEs and the coding rate provided by the CCEs. The BS determines a PDCCH format according to a DCI to be transmitted to the UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging indicator identifier (e.g., paging-RNTI (P-RNTI)) may be masked to the CRC. If the PDCCH is for system information (more specifically, a system information block (SIB) to be described below), a system information identifier and a system information RNTI (SI-RNTI) may be masked to the CRC. To indicate a random access response that is a response for transmission of a random access preamble of the UE, a random access-RNTI (RA-RNTI) may be masked to the CRC.

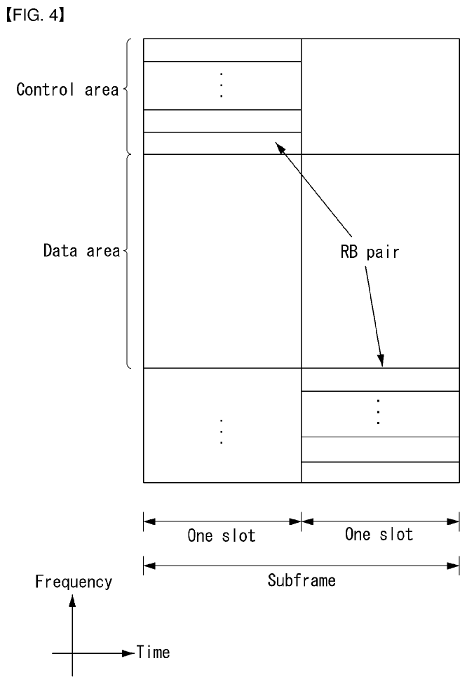

FIG. 4 illustrates an example of the structure of uplink subframe.

In FIG. 4, an uplink subframe can be divided in a frequency domain into a control region and a data region. The control region is allocated with a physical uplink control channel (PUCCH) for carrying uplink control information. The data region is allocated with a physical uplink shared channel (PUSCH) for carrying user data. To maintain a single carrier property, one UE does not simultaneously transmit the PUCCH and the PUSCH. The PUCCH for one UE is allocated to an RB pair in a subframe. RBs belonging to the RB pair occupy different subcarriers in respective two slots. This is called that the RB pair allocated to the PUCCH is frequency-hopped in a slot boundary.

Hereinafter, the LTE frame structure will be described in more detail.

Throughout LTE specification, unless otherwise noted, the size of various fields in the time domain is expressed as a number of time units Tₛ=1/(15000×2048) seconds.

Downlink and uplink transmissions are organized into radio frames with T_{f}=307200×Tₛ=10 ms duration. Two radio frame structures are supported:

Type 1, applicable to FDD

Type 2, applicable to TDD

Frame Structure Type 1

Frame structure type 1 is applicable to both full duplex and half duplex FDD. Each radio frame is T_{f}=307200·Tₛ=10 ms long and consists of 20 slots of length Tₛₗₒₜ=15360·Tₛ=0.5 ms, numbered from 0 to 19. A subframe is defined as two consecutive slots where subframe i consists of slots 2i and 2i +1.

For FDD, 10 subframes are available for downlink transmission and 10 subframes are available for uplink transmissions in each 10 ms interval.

Uplink and downlink transmissions are separated in the frequency domain. In half-duplex FDD operation, the UE cannot transmit and receive at the same time while there are no such restrictions in full-duplex FDD.

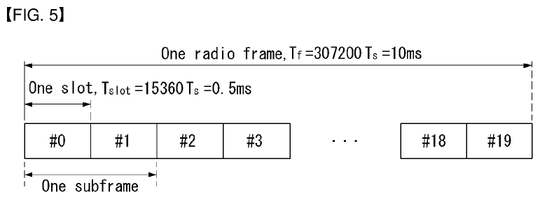

FIG. 5 illustrates an example of the frame structure type 1.

Frame Structure Type 2

Frame structure type 2 is applicable to FDD. Each radio frame of length T_{f}=307200×Tₛ=10 ms consists of two half-frames of length 15360·Tₛ=0.5 ms each. Each half-frame consists of five subframes of length 30720·Tₛ=1 ms. The supported uplink-downlink configurations are listed in Table 2 where, for each subframe in a radio frame, “D” denotes the subframe is reserved for downlink transmissions, “U” denotes the subframe is reserved for uplink transmissions and “S” denotes a special subframe with the three fields DwPTS, GP and UpPTS. The length of DwPTS and UpPTS is given by Table 1 subject to the total length of DwPTS, GP and UpPTS being equal to 30720·Tₛ=1 ms. Each subframe i is defined as two slots, 2i and 2i+1 of length Tₛₗₒₜ=15360·Tₛ=0.5 ms in each subframe.

Uplink-downlink configurations with both 5 ms and 10 ms downlink-to-uplink switch-point periodicity are supported. In case of 5 ms downlink-to-uplink switch-point periodicity, the special subframe exists in both half-frames. In case of 10 ms downlink-to-uplink switch-point periodicity, the special subframe exists in the first half-frame only. Subframes 0 and 5 and DwPTS are always reserved for downlink transmission. UpPTS and the subframe immediately following the special subframe are always reserved for uplink transmission.

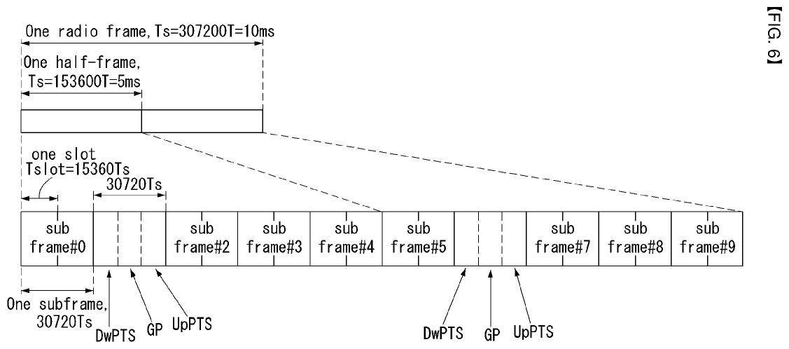

FIG. 6 is a diagram illustrating another example of the frame structure type 2.

Table 1 shows an example of a configuration of a special subframe.

TABLE 1

| | normal cyclic prefix in downlink | | | extended cyclic prefix in downlink | | |
|---|---|---|---|---|---|---|
| | | UpPTS | | | UpPTS | |
| Special | | normal | extended | | normal | extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

Table 2 shows an example of an uplink-downlink configuration.

TABLE 2

| Uplink- | Downlink- | | | | | | | | | | | |
|---|---|---|---|---|---|---|---|---|---|---|---|---|
| Downlink | to-Uplink | | | | | | | | | | | |
| config- | Switch-point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

NB-IoT

NB-IoT (narrowband-internet of things) is a standard for supporting low complexity and low cost devices and is defined to perform only relatively simple operations compared to existing LTE devices. NB-IoT follows the basic structure of LTE, but operates based on the contents defined below. If the NB-IoT reuses an LTE channel or signal, it may follow the standard defined in the existing LTE.

Uplink

The following narrowband physical channels are defined:

NPUSCH (Narrowband Physical Uplink Shared Channel)

NPRACH (Narrowband Physical Random Access Channel)

The following uplink narrowband physical signals are defined:

Narrowband demodulation reference signal

The uplink bandwidth in terms of subcarriers N_{sc}^{UL}, and the slot duration Tₛₗₒₜ are given in Table 3Error! Reference source not found.

Table 3 shows an example of NB-IoT parameters.

TABLE 3

| Subcarrier spacing | N_{sc}^{UL} | Tₛₗₒₜ |
|---|---|---|
| Δf = 3.75 kHz | 48 | 61440 · Tₛ |
| Δf = 15 kHz | 12 | 15360 · Tₛ |

A single antenna port p=0 is used for all uplink transmissions.

Resource Unit

Resource units are used to describe the mapping of the NPUSCH to resource elements. A resource unit is defined as N_{symb}^{UL}Nₛₗₒₜₛ^{UL} consecutive SC-FDMA symbols in the time domain and N_{sc}^{RU} consecutive subcarriers in the frequency domain, where N_{sc}^{RU} and N_{symb}^{UL} are given by Table 4.

Table 4 shows an example of supported combinations of N_{sc}^{RU}, Nₛₗₒₜₛ^{UL} and N_{symb}^{UL}.

TABLE 4

| | | | | |
|---|---|---|---|---|
| NPUSCH format | Δf | N_{sc}^{RU} | Nₛₗₒₜₛ^{UL} | N_{symb}^{UL} |

| | | | | | |
|---|---|---|---|---|---|
| 1 | 3.75 | kHz | 1 | 16 | 7 |
| | 15 | kHz | 1 | 16 | |
| | | | 3 | 8 | |
| | | | 6 | 4 | |
| | | | 12 | 2 | |
| 2 | 3.75 | kHz | 1 | 4 | |
| | 15 | kHz | 1 | 4 | |

Narrowband Uplink Shared Channel (NPUSCH)

The narrowband physical uplink shared channel supports two formats:

NPUSCH format 1, used to carry the UL-SCH

NPUSCH format 2, used to carry uplink control information

Scrambling shall be done according to clause 5.3.1 of TS36.211. The scrambling sequence generator shall be initialized with cᵢₙᵢ=n_{RNTI}·2¹⁴+n_{f} mod 2·2¹³+[nₛ/2]+N_{ID}^{Ncell} where nₛ is the first slot of the transmission of the codeword. In case of NPUSCH repetitions, the scrambling sequence shall be reinitialized according to the above formula after every M_{idendical}^{NPUSCH} transmission of the codeword with nₛ and n_{f} set to the first slot and the frame, respectively, used for the transmission of the repetition. The quantity M_{idendical}^{NPUSCH} is given by clause 10.1.3.6 in TS36.211.

Table 5 specifies the modulation mappings applicable for the narrowband physical uplink shared channel.

TABLE 5

| NPUSCH format | N_{sc}^{RU} | Modulation scheme |
|---|---|---|
| 1 | 1 | BPSK, QPSK |
| | >1 | QPSK |
| 2 | 1 | BPSK |

NPUSCH can be mapped to one or more than one resource units, N_{RU}, as given by clause 16.5.1.2 of 3GPP TS 36.213, each of which shall be transmitted Mᵣₑₚ^{NPUSCH} times.

The block of complex-valued symbols z(0), . . . , z(Mᵣₑₚ^{NPUSCH}-1) shall be multiplied with the amplitude scaling factor β_{NPUSCH} in order to conform to the transmit power P_{NPUSCH} specified in 3GPP TS 36.213, and mapped in sequence starting with z(0) to subcarriers assigned for transmission of NPUSCH. The mapping to resource elements (k, l) corresponding to the subcarriers assigned for transmission and not used for transmission of reference signals, shall be in increasing order of first the index k, then the index l, starting with the first slot in the assigned resource unit.

After mapping to Nₛₗₒₜₛ slots, the Nₛₗₒₜₛ slots shall be repeated M_{idendical}^{NPUSCH}-1 additional times, before continuing the mapping of z(·) to the following slot, where Equation 1,

$${M}_{i d e n d ical}^{NPUSCH} = \{ \begin{matrix}in ( ⌈ {M}_{rep}^{NPUSCH} / 2 ⌉ , 4 ) & {N}_{sc}^{R U} > 1 \\ 1 & {N}_{sc}^{R U} = 1\end{matrix} \\ {N}_{s l o t s} = \{ \begin{matrix}1 & Δ f = 3.75 kHz \\ 2 & Δ f = 15 kHz\end{matrix} \qquad [ Equation 1 ]$$

If a mapping to Nₛₗₒₜₛ slots or a repetition of the mapping contains a resource element which overlaps with any configured NPRACH resource according to NPRACH-ConfigSIB-NB, the NPUSCH transmission in overlapped Nₛₗₒₜₛ slots is postponed until the next Nₛₗₒₜₛ slots not overlapping with any configured NPRACH resource.

The mapping of z(0), . . . , z(Mᵣₑₚ^{NPUSCH}-1) is then repeated until Mᵣₑₚ^{NPUSCH} N_{RU}Nₛₗₒₜₛ^{UL} slots have been transmitted. After transmissions and/or postponements due to NPRACH of 256·30720Tₛ time units, a gap of 40·30720Tₛ time units shall be inserted where the NPUSCH transmission is postponed. The portion of a postponement due to NPRACH which coincides with a gap is counted as part of the gap.

When higher layer parameter npusch-AllSymbols is set to false, resource elements in SC-FDMA symbols overlapping with a symbol configured with SRS according to srs-SubframeConfig shall be counted in the NPUSCH mapping but not used for transmission of the NPUSCH. When higher layer parameter npusch-AllSymbols is set to true, all symbols are transmitted.

Uplink control information on NPUSCH without UL-SCH data

The one bit information of HARQ-ACK o₀^{ACK} is coded according to Table 6, where for a positive acknowledgement o₀^{ACK}=1 and for a negative acknowledgement o₀^{ACK}=0.

Table 6 shows an example of HARQ-ACK code words.

TABLE 6

| HARQ-ACK | HARQ-ACK |
|---|---|
| <o₀^{ACK}> | <b₀, b₁, b₂, . . . , b₁₅> |
| 0 | <0, 0, 0, 0, 0, 0, 0, 0, 0, 0, 0, 0, 0, 0, 0, 0> |
| 1 | <1, 1, 1, 1, 1, 1, 1, 1, 1, 1, 1, 1, 1, 1, 1, 1> |

Power Control

The UE transmit power for NPUSCH transmission in NB-IoT UL slot i for the serving cell is given by Equation 2 and 3 below.

If the number of repetitions of the allocated NPUSCH RUs is greater than 2,

$$\begin{matrix} {P}_{N P U SCH , c} ( i ) = {P}_{C MAX , c} ( i ) [ dBm ] & [ Equation 2 ] \\ Otherwise & \\ {P}_{N P U SCH , c} ( i ) = min \\ \{ \begin{matrix}{P}_{C MAX , c} ( i ) , \\ 10 {log}_{10} ( {M}_{N P U SCH , c} ( i ) ) + {P}_{O \_ NPUSCH , c} ( j ) + {α}_{c} ( j ) \cdot {PL}_{c}\end{matrix} \} [ dBm ] & [ Equation 3 ]\end{matrix}$$

where, P_{CMAX,c}(i) is the configured UE transmit power defined in 3GPP TS36.101 in NB-IoT UL slot i for serving cell c.

M_{NPUSCH,c} is {1/4} for 3.75 kHz subcarrier spacing and {1, 3, 6, 12} for 15 kHz subcarrier spacing

P_{O_NPUSCH,c}(j) is a parameter composed of the sum of a component P_{O_NOMINAL_NPUSCH,c}(j) provided from higher layers and a component P_{O_UE_NPUSCH,c}(j) provided by higher layers for j=1 and for serving cell c where j ∈ {1,2}. For NPUSCH (re)transmissions corresponding to a dynamic scheduled grant then j=1 and for NPUSCH (re)transmissions corresponding to the random access response grant then j=2.

P_{O_UE_NPUSCH,c}(2)=0 and P_{O_NORMINAL_NPUSCH,c}(2)=P_{O_PRE}+Δ_{PREAMBLE_Msg3}, where the parameter preambleInitialReceivedTargetPower P_{O_PRE} and Δ_{PREAMBLE_Msg3} are signalled from higher layers for serving cell c.

For j=1, for NPUSCH format 2, α_{c}(j)=1; for NPUSCH format 1, α_{c}(j) is provided by higher layers for serving cell c. For j=2, α_{c}(j)=1.

PL_{c} is the downlink path loss estimate calculated in the UE for serving cell c in dB and PL_{c}=nrs-Power+nrs-PowerOffsetNonAnchor−higher layer filtered NRSRP, where nrs-Power is provided by higher layers and Subclause 16.2.2 in 3GPP 36.213, and nrs-powerOffsetNonAnchor is set to zero if it is not provided by higher layers and NRSRP is defined in 3GPP TS 36.214 for serving cell c and the higher layer filter configuration is defined in 3GPP TS 36.331 for serving cell c.

If the UE transmits NPUSCH in NB-IoT UL slot i for serving cell c, power headroom is computed using Equation 4 below.

PH_{c}(i)=P_{CMAX,c}(i)−{P_{O_NPUSCH,c}(1)+α_{c}(1)·PL_{c}}[dB] [Equation 4]

UE Procedure for Transmitting Format 1 NPUSCH

A UE shall upon detection on a given serving cell of a NPDCCH with DCI format N0 ending in NB-IoT DL subframe n intended for the UE, perform, at the end of n+k₀ DL subframe, a corresponding NPUSCH transmission using NPUSCH format 1 in N consecutive NB-IoT UL slots nᵢ with i=0,1, . . . , N-1 according to the NPDCCH information where

subframe n is the last subframe in which the NPDCCH is transmitted and is determined from the starting subframe of NPDCCH transmission and the DCI subframe repetition number field in the corresponding DCI; and

N=N_{Rep}N_{RU}Nₛₗₒₜₛ ^{UL}, where the value of N_{Rep} is determined by the repetition number field in the corresponding DCI, the value of N_{RU} is determined by the resource assignment field in the corresponding DCI, and the value of Nₛₗₒₜₛ^{UL} is the number of NB-IoT UL slots of the resource unit corresponding to the allocated number of subcarriers in the corresponding DCI,

n₀ is the first NB-IoT UL slot starting after the end of subframe n+k₀

value of k₀ is determined by the scheduling delay field (I_{Delay}) in the corresponding DCI according to Table 7.

Table 7 shows an example of k0 for DCI format N0.

TABLE 7

| I_{Delay} | k₀ |
|---|---|
| 0 | 8 |
| 1 | 16 |
| 2 | 32 |
| 3 | 64 |

The resource allocation information in uplink DCI format N0 for NPUSCH transmission indicates to a scheduled UE

a set of contiguously allocated subcarriers (n_{sc}) of a resource unit determined by the Subcarrier indication field in the corresponding DCI,

a number of resource units (N_{RU}) determined by the resource assignment field in the corresponding DCI according to Table 9,

a repetition number (N_{Rep}) determined by the repetition number field in the corresponding DCI according to Table 10.

The subcarrier spacing Δf of NPUSCH transmission is determined by the uplink subcarrier spacing field in the Narrowband Random Access Response Grant according to Subclause 16.3.3 in 3GPP TS36.213.

For NPUSCH transmission with subcarrier spacing Δf=3.75 kHz, n_{sc}=I_{sc} where I_{sc} is the subcarrier indication field in the DCI.

For NPUSCH transmission with subcarrier spacing Δf=15 kHz, the subcarrier indication field (I_{sc}) in the DCI determines the set of contiguously allocated subcarriers (n_{sc}) according to Table 8.

Table 8 shows an example of subcarriers allocated to the NPUSCH having Δf=15 kHz.

TABLE 8

| Subcarrier indication field (I_{sc}) | Set of Allocated subcarriers (n_{sc}) |
|---|---|
| 0-11 | I_{sc} |
| 12-15 | 3(I_{sc} − 12) + {0, 1, 2} |
| 16-17 | 6(I_{sc} − 16) + {0, 1, 2, 3, 4, 5} |
| 18 | {0, 1, 2, 3, 4, 5, 6, 7, 8, 9, 10, 11} |
| 19-63 | Reserved |

Table 9 shows an example of the number of resource units for NPUSCH.

TABLE 9

| I_{RU} | N_{RU} |
|---|---|
| 0 | 1 |
| 1 | 2 |
| 2 | 3 |
| 3 | 4 |
| 4 | 5 |
| 5 | 6 |
| 6 | 8 |
| 7 | 10 |

Table 10 shows an example of the number of repetitions for NPUSCH.

TABLE 10

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |

Demodulation Reference Signal (DMRS)

The reference signal sequence r̅ᵤ(n) for N_{sc}^{RU}=1 is defined by Equation 5 below.

$$\begin{matrix}{\overline{r}}_{u} ( n ) = \frac{1}{\sqrt{2}} ( 1 + j ) ( 1 - 2 c ( n ) ) w ( n mod 16 ) , \\ < {M}_{r e p}^{N P U S C H} {N}_{R U} {N}_{slots}^{U L}\end{matrix} 0 \leq n \qquad [ Equation 5 ]$$

where the binary sequence c(n) is defined by clause 7.2 of TS36.211 and shall be initialized with cᵢₙᵢₜ=35 at the start of the NPUSCH transmission. The quantity w(n) is given by Error! Reference source not found. where u=N_{ID}^{Ncell} mod 16 for NPUSCH format 2, and for NPUSCH format 1 if group hopping is not enabled, and by clause 10.1.4.1.3 of 3GPP TS36.211 if group hopping is enabled for NPUSCH format 1.

Table 11 shows an example of w(n).

TABLE 11

| u | w(0), . . . , w(15) | | | | | | | | | | | | | | | |
|---|---|---|---|---|---|---|---|---|---|---|---|---|---|---|---|---|
| 0 | 1 | 1 | 1 | 1 | 1 | 1 | 1 | 1 | 1 | 1 | 1 | 1 | 1 | 1 | 1 | 1 |
| 1 | 1 | −1 | 1 | −1 | 1 | −1 | 1 | −1 | 1 | −1 | 1 | −1 | 1 | −1 | 1 | −1 |
| 2 | 1 | 1 | −1 | −1 | 1 | 1 | −1 | −1 | 1 | 1 | −1 | −1 | 1 | 1 | −1 | −1 |
| 3 | 1 | −1 | −1 | 1 | 1 | −1 | −1 | 1 | 1 | −1 | −1 | 1 | 1 | −1 | −1 | 1 |
| 4 | 1 | 1 | 1 | 1 | −1 | −1 | −1 | −1 | 1 | 1 | 1 | 1 | −1 | −1 | −1 | −1 |
| 5 | 1 | −1 | 1 | −1 | −1 | 1 | −1 | 1 | 1 | −1 | 1 | −1 | −1 | 1 | −1 | 1 |
| 6 | 1 | 1 | −1 | −1 | −1 | −1 | 1 | 1 | 1 | 1 | −1 | −1 | −1 | −1 | 1 | 1 |
| 7 | 1 | −1 | −1 | 1 | −1 | 1 | 1 | −1 | 1 | −1 | −1 | 1 | −1 | 1 | 1 | −1 |
| 8 | 1 | 1 | 1 | 1 | 1 | 1 | 1 | 1 | −1 | −1 | −1 | −1 | −1 | −1 | −1 | −1 |
| 9 | 1 | −1 | 1 | −1 | 1 | −1 | 1 | −1 | −1 | 1 | −1 | 1 | −1 | 1 | −1 | 1 |
| 10 | 1 | 1 | −1 | −1 | 1 | 1 | −1 | −1 | −1 | −1 | 1 | 1 | −1 | −1 | 1 | 1 |
| 11 | 1 | −1 | −1 | 1 | 1 | −1 | −1 | 1 | −1 | 1 | 1 | −1 | −1 | 1 | 1 | −1 |
| 12 | 1 | 1 | 1 | 1 | −1 | −1 | −1 | −1 | −1 | −1 | −1 | −1 | 1 | 1 | 1 | 1 |
| 13 | 1 | −1 | 1 | −1 | −1 | 1 | −1 | 1 | −1 | 1 | −1 | 1 | 1 | −1 | 1 | −1 |
| 14 | 1 | 1 | −1 | −1 | −1 | −1 | 1 | 1 | −1 | −1 | 1 | 1 | 1 | 1 | −1 | −1 |
| 15 | 1 | −1 | −1 | 1 | −1 | 1 | 1 | −1 | −1 | 1 | 1 | −1 | 1 | −1 | −1 | 1 |

The reference signal sequence for NPUSCH format 1 is given by Equation 6 below.

rᵤ(n)=r̅ᵤ(n) [Equation 6]

The reference signal sequence for NPUSCH format 2 is given by Equation 7 below.

rᵤ(3n+m)=w̅(m)r̅ᵤ(n), m=0,1,2 [Equation 7]

where w̅(m) is defined in Table 5.5.2.2.1-2 of 3GPP TS36.211 with the sequence index chosen according to

$$( {\sum }_{i = 0}^{7} c ( 8 {n}_{s} + i ) {2}^{i} ) mod 3$$

with cᵢₙᵢₜ=N_{ID}^{Ncell}.

The reference signal sequences rᵤ(n) for N_{sc}^{RU}>1 is defined by a cyclic shift α of a base sequence according to Equation 8 below.

rᵤ(n)=e^{jan}e^{jϕ(n)π/4}, 0≤n<N_{sc}^{RU} [Equation 8]

where φ(n) is given by Table 10.1.4.1.2-1 for N_{sc}^{RU}=3, Table 12 for N_{sc}^{RU}=6 and Table 13 for N_{sc}^{RU}=12.

If group hopping is not enabled, the base sequence index u is given by higher layer parameters threeTone-BaseSequence, sixTone-BaseSequence, and twelveTone-BaseSequence for N_{sc}^{RU}3, N_{sc}^{RU}=6, and N_{sc}^{RU}=12, respectively. If not signalled by higher layers, the base sequence is given by Equation 9 below.

$$u = \{ \begin{matrix}{N}_{I D}^{Ncell} mod 12 & for {N}_{sc}^{R U} = 3 \\ {N}_{I D}^{N cell} mod 14 & for {N}_{sc}^{R U} = 6 \\ {N}_{I D}^{Ncell} mod 30 & for {N}_{sc}^{R U} = 12\end{matrix} \qquad [ Equation 9 ]$$

If group hopping is enabled, the base sequence index u is given by clause 10.1.4.1.3 of 3GPP TS36.211.

The cyclic shift α for N_{sc}^{RU}=3 and N_{sc}^{RU}=6 is derived from higher layer parameters threeTone-CyclicShift and sixTone-CyclicShift, respectively, as defined in Table 14. For N_{sc}^{RU}=12, α=0.

Table 12 shows an example of φ(n) for N_{sc}^{RU}=3

TABLE 12

| u | φ(0), φ(1), φ(2) | | |
|---|---|---|---|
| 0 | 1 | −3 | −3 |
| 1 | 1 | −3 | −1 |
| 2 | 1 | −3 | 3 |
| 3 | 1 | −1 | −1 |
| 4 | 1 | −1 | 1 |
| 5 | 1 | −1 | 3 |
| 6 | 1 | 1 | −3 |
| 7 | 1 | 1 | −1 |
| 8 | 1 | 1 | 3 |
| 9 | 1 | 3 | −1 |
| 10 | 1 | 3 | 1 |
| 11 | 1 | 3 | 3 |

Table 13 shows another example of φ(n) for N_{sc}^{RU}=6

TABLE 13

| | |
|---|---|
| u | φ(0), . . . , φ(5) |

| | | | | | | |
|---|---|---|---|---|---|---|
| 0 | 1 | 1 | 1 | 1 | 3 | −3 |
| 1 | 1 | 1 | 3 | 1 | −3 | 3 |
| 2 | 1 | −1 | −1 | −1 | 1 | −3 |
| 3 | 1 | −1 | 3 | −3 | −1 | −1 |
| 4 | 1 | 3 | 1 | −1 | −1 | 3 |
| 5 | 1 | −3 | −3 | 1 | 3 | 1 |
| 6 | −1 | −1 | 1 | −3 | −3 | −1 |
| 7 | −1 | −1 | −1 | 3 | −3 | −1 |
| 8 | 3 | −1 | 1 | −3 | −3 | 3 |
| 9 | 3 | −1 | 3 | −3 | −1 | 1 |
| 10 | 3 | −3 | 3 | −1 | 3 | 3 |
| 11 | −3 | 1 | 3 | 1 | −3 | −1 |
| 12 | −3 | 1 | −3 | 3 | −3 | −1 |
| 13 | −3 | 3 | −3 | 1 | 1 | −3 |

Table 14 shows an example of α

TABLE 14

| | |
|---|---|
| N_{sc}^{RU} = 3 | N_{sc}^{RU} = 6 |

| threeTone-CyclicShift | α | sixTone-CyclicShift | α |
|---|---|---|---|
| 0 | 0 | 0 | 0 |
| 1 | 2π/3 | 1 | 2π/6 |
| 2 | 4π/3 | 2 | 4π/6 |
| | | 3 | 8π/6 |

For the reference signal for NPUSCH format 1, sequence-group hopping can be enabled where the sequence-group number u in slot nₛ is defined by a group hopping pattern f_{gh}(uₛ) and a sequence-shift pattern fₛₛ according to Equation 10 below.

u=(f_{gh}(nₛ)+fₛₛ)mod N_{deq}^{RU} [Equation 10]

where the number of reference signal sequences available for each resource unit size, N_{seq}^{RU} is given by Table 15.

Table 15 shows an example of N_{seq}^{RU}

TABLE 15

| N_{sc}^{RU} | N_{seq}^{RU} |
|---|---|
| 1 | 16 |
| 3 | 12 |
| 6 | 14 |
| 12 | 30 |

Sequence-group hopping can be enabled or disabled by means of the cell-specific parameter groupHoppingEnabled provided by higher layers. Sequence-group hopping for NPUSCH can be disabled for a certain UE through the higher-layer parameter groupHoppingDisabled despite being enabled on a cell basis unless the NPUSCH transmission corresponds to a Random Access Response Grant or a retransmission of the same transport block as part of the contention based random access procedure.

The group hopping pattern f_{gh}(nₛ) is given by Equation 11 below .

f_{gh}(nₛ)=(Σᵢ₌₀⁷c(8n′ₛ+i)·2ⁱ)mod N_{seq}^{RU} [Equation 11]

where n′ₛ=nₛ for N_{sc}^{RU}>1 and n′ₛ is the slot number of the first slot of the resource unit for N_{sc}^{RU}=1. The pseudo-random sequence c(i) is defined by clause 7.2. The pseudo-random sequence generator shall be initialized with

$${c}_{init} = ⌊ \frac{{N}_{I D}^{Ncell}}{{N}_{seq}^{R U}} ⌋$$

at the beginning of the resource unit for N_{sc}^{RU}=1 and in every even slot for N_{sc}^{R}>1.

The sequence-shift pattern fₛₛ is given by Equation 12 below.

fₛₛ=(N_{ID}^{Ncell}+Δₛₛ)mod N_{seq}^{RU} [Equation 12]

where Δₛₛ ∈ {0,1, . . . , 29} is given by higher-layer parameter groupAssignmentNPUSCH. If no value is signalled, Δₛₛ=0.

The sequence r(·) shall be multiplied with the amplitude scaling factor β_{NPUSCH} and mapped in sequence starting with r(0) to the sub-carriers.

The set of sub-carriers used in the mapping process shall be identical to the corresponding NPUSCH transmission as defined in clause 10.1.3.6 in 3GPP 36.211.

The mapping to resource elements (k, l) shall be in increasing order of first k, then l, and finally the slot number. The values of the symbol index l in a slot are given in Table 16.

Table 16 shows an example of demodulation reference signal location for NPUSCH

TABLE 16

Values for l

| NPUSCH format | Δf = 3.75 kHz | Δf = 15 kHz |
|---|---|---|
| 1 | 4 | 3 |
| 2 | 0, 1, 2 | 2, 3, 4 |

SF-FDMA Baseband Signal Generation

For N_{sc}^{RU}>1, the time-continuous signal sₗ(t) in SC-FDMA symbol l in a slot is defined by clause 5.6 with the quantity N_{RB}^{UL}N_{sc}^{RB} replaced by N_{sc}^{UL}.

For N_{sc}^{RU}=1, the time-continuous signal s_{k,l}(t) for sub-carrier index k in SC-FDMA symbol l in an uplink slot is defined by Equation 13 below

s_{k,l}(t)=aₖ_{^{(−)}}_{,l}·e^{jϕ}^{_{k,l}}·e^{j2π(k+1/2)Δf(t-N}^{_{CP,l}}^{T}^{ₛ₎}

k⁽⁻⁾=k+└N_{sc}^{UL}/2┘ [Equation 13]

For 0≤t<(N_{CP,l}+N)Tₛ where parameters for Δf=15 kHz and Δf=3.75 kHz are given in Table 17, aₖ_{^{(−)}}_{,l} is the modulation value of symbol l and the phase rotation φ_{k,l} is defined by Equation 14 below.

$${φ}_{k , l} = ρ ( \tilde{l} mod 2 ) + {\hat{φ}}_{k} ( \tilde{l} ) \\ ρ = \{ \begin{matrix}\frac{π}{2} & for BPSK \\ \frac{π}{4} & for QPSK\end{matrix} \\ {\hat{φ}}_{k} ( \tilde{l} ) = \{ \begin{matrix}0 & \tilde{l} = 0 \\ {\hat{φ}}_{k} ( \tilde{l} - 1 ) + 2 πΔ f ( k + 1 / 2 ) ( N + {N}_{CP , l} ) {T}_{s} & \tilde{l} > 0\end{matrix} \\ \tilde{l} = 0 , 1 , … , {M}_{rep}^{NPUSCH} {N}_{RU} {N}_{slots}^{UL} {N}_{symb}^{UL} - 1 \\ l = \tilde{l} {mod N}_{symb}^{UL} \qquad [ Equation 14 ]$$

where \tilde{l} is a symbol counter that is reset at the start of a transmission and incremented for each symbol during the transmission.

Table 17 shows an example of SC-FDMA parameters for N_{sc}^{RU}=1.

TABLE 17

| Parameter | Δf = 3.75 kHz | Δf = 15 kHz |
|---|---|---|
| N | 8192 | 2048 |
| Cyclic prefix length | 256 | 160 for l = 0 |
| N_{CP, l} | | 144 for l = 1, 2, . . . , 6 |
| Set of values for k | −24, −23, . . . , 23 | −6, −5, . . . , 5 |

The SC-FDMA symbols in a slot shall be transmitted in increasing order of l, starting with l=0, where SC-FDMA symbol l>0 starts at time Σ_{l′=0}^{t-1}(N_{CP,l′}+N)Tₛ within the slot. For Δf=3.75 kHz, the remaining 2304Tₛ in Tₛₗₒₜ are not transmitted and used for guard period.

Narrowband physical random access channel (NPRACH)

The physical layer random access preamble is based on single-subcarrier frequency-hopping symbol groups. A symbol group is illustrated in Error! Reference source not found., consisting of a cyclic prefix of length T_{CP} and a sequence of 5 identical symbols with total length T_{SEQ}. The parameter values are listed in Table 18.

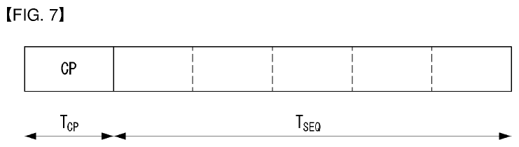

FIG. 7 illustrates an example of the random access symbol group.

Table 18 shows an example of Random access preamble parameters.

TABLE 18

| Preamble format | T_{CP} | T_{SEQ} |
|---|---|---|
| 0 | 2048Tₛ | 5 · 8192Tₛ |
| 1 | 8192Tₛ | 5 · 8192Tₛ |

The preamble consisting of 4 symbol groups transmitted without gaps shall be transmitted Nᵣₑₚ^{NPRACH} times.

The transmission of a random access preamble, if triggered by the MAC layer, is restricted to certain time and frequency resources.

A NPRACH configuration provided by higher layers contains the following:

NPRACH resource periodicity N_{period}^{NPRACH} (nprach-Periodicity),

frequency location of the first subcarrier allocated to NPRACH N_{scoffset}^{NPRACH} (nprach-SubcarrierOffset),

number of subcarriers allocated to NPRACH N_{sc}^{NPRACH} (nprach-NumSubcarriers),

number of starting sub-carriers allocated to contention based NPRACH random access N_{sc_cont}^{NPRACH} (nprach-NumCBRA-StartSubcarriers),

number of NPRACH repetitions per attempt Nᵣₑₚ^{NPRACH} (num RepetitionsPerPreambleAttem pt),

NPRACH starting time Nₛₜₐᵣₜ^{NPRACH} (nprach-StartTime),

Fraction for calculating starting subcarrier index for the range of NPRACH subcarriers reserved for indication of UE support for multi-tone msg3 transmission N_{MSG3}^{NPRACH} (nprach-SubcarrierMSG3-RangeStart).

NPRACH transmission can start only Nₛₜₐᵣₜ^{NPRACH}·30720 Tₛ time units after the start of a radio frame fulfilling n_{f} mod(N_{period}^{NPRACH}/10)=0. After transmissions of 4·64(T_{CP}+T_{SEQ}) time units, a gap of 40·30720Tₛ time units shall be inserted.

NPRACH configurations where N_{scoffset}^{NPRACH}+N_{sc}^{NPRACH}>N_{sc}^{UL} are invalid.

The NPRACH starting subcarriers allocated to contention based random access are split in two sets of subcarriers, {0,1, . . . , N_{sc}_{_{cont}}^{NPRACH}N_{MSG3}^{NPRACH}−1} and {N_{sc_cont}^{NPRACH}N_{MSG3}^{NPRACH}, . . . , N_{sc}_{_{cont}}^{NPRACH}−1}, where the second set, if present, indicate UE support for multi-tone msg3 transmission.

The frequency location of the NPRACH transmission is constrained within N_{sc}^{RA}=12 sub-carriers. Frequency hopping shall be used within the 12 subcarriers, where the frequency location of the i^{th} symbol group is given by n_{sc}^{RA}(i)=nₛₜₐᵣₜ+ñ_{sc}^{RA}(i) where nₛₜₐᵣₜ=N_{scoffset}^{NRPACH}+└nᵢₙᵢₜ/N_{sc}^{RA}┘·N_{sc}^{RA} and Equation 15,

$${\tilde{n}}_{sc}^{R A} ( i ) = \\ \{ \begin{matrix}( {\tilde{n}}_{sc}^{R A} ( 0 ) + f ( i / 4 ) ) {mod N}_{sc}^{R A} & i mod 4 = 0 and i > 0 \\ {\tilde{n}}_{sc}^{R A} ( i - 1 ) + 1 & i mod 4 = 1 , 3 and {\tilde{n}}_{sc}^{R A} ( i - 1 ) mod 2 = 0 \\ {\tilde{n}}_{sc}^{R A} ( i - 1 ) - 1 & i mod 4 = 1 , 3 and {\tilde{n}}_{sc}^{R A} ( i - 1 ) mod 2 = 1 \\ {\tilde{n}}_{sc}^{R A} ( i - 1 ) + 6 & i mod 4 = 2 and {\tilde{n}}_{sc}^{R A} ( i - 1 ) < 6 \\ {\tilde{n}}_{sc}^{R A} ( i - 1 ) - 6 & i mod 4 = 2 and {\tilde{n}}_{sc}^{R A} ( i - 1 ) \geq 6\end{matrix} \\ f ( t ) = ( f ( t - 1 ) + ( {\sum }_{n = 10 t + 1}^{10 t + 9} c ( n ) {2}^{n - ( 10 t + 1 )} ) mod ( {N}_{sc}^{RA} - 1 ) + 1 ) {mod N}_{sc}^{RA} \\ f ( - 1 ) = 0 \qquad [ Equation 15 ]$$

where ñ_{SC}^{RA}(0)=nᵢₙᵢₜ mod N_{sc}^{RA} with nᵢₙᵢₜ being the subcarrier selected by the MAC layer from {0,1, . . . , N_{sc}^{NPRACH}−1} and the pseudo random sequence c(n) is given by clause 7.2 of 3GPP TS36.211. The pseudo random sequence generator shall be initialised with cᵢₙᵢₜ=N_{ID}^{Ncell}.

The time-continuous random access signal sᵢ(t) for symbol group i is defined by Equation 16 below.

sᵢ(t)=β_{NPRACH}e^{j2π(n}^{_{SC}}^{^{RA}}^{(i)+Kk}^{₀}^{+1/2)Δf}^{_{RA}}^{(t-T}^{_{CP}}⁾ [Equation 16]

Where 0≤t<T_{SEQ}+T_{CP}, β_{NPRACH} is an amplitude scaling factor in order to conform to the transmit power P_{NPRACH} specified in clause 16.3.1 in 3GPP TS 36.213, k₀=N_{sc}^{UL}/2, K=Δf/Δf_{RA} accounts for the difference in subcarrier spacing between the random access preamble and uplink data transmission, and the location in the frequency domain controlled by the parameter n_{sc}^{RA}(i) is derived from clause 10.1.6.1 of 3GPP TS36.211. The variable Δf_{RA} is given by Table 19 below.

Table 19 shows an example of random access baseband parameters.

TABLE 19

| Preamble format | Δf_{RA} |
|---|---|
| 0, 1 | 3.75 kHz |

Downlink

A downlink narrowband physical channel corresponds to a set of resource elements carrying information originating from higher layers and is the interface defined between 3GPP TS 36.212 and 3GPP TS 36.211.

The following downlink physical channels are defined:

NPDSCH (Narrowband Physical Downlink Shared Channel)

NPBCH (Narrowband Physical Broadcast Channel)

NPDCCH (Narrowband Physical Downlink Control Channel)

A downlink narrowband physical signal corresponds to a set of resource elements used by the physical layer but does not carry information originating from higher layers. The following downlink physical signals are defined:

NRS (Narrowband reference signal)

Narrowband synchronization signal

Narrowband physical downlink shared channel (NPDSCH)

The scrambling sequence generator shall be initialized with cᵢₙᵢ=n_{RNTI}·2¹⁴+n_{f} mod 2·2¹³+└nₛ/2┘+N_{ID}^{Ncell} where nₛ is the first slot of the transmission of the codeword. In case of NPDSCH repetitions and the NPDSCH carrying the BCCH, the scrambling sequence generator shall be reinitialized according to the expression above for each repetition. In case of NPDSCH repetitions and the NPDSCH is not carrying the BCCH, the scrambling sequence generator shall be reinitialized according to the expression above after every min(Mᵣₑₚ^{NPDSCH},4) transmission of the codeword with nₛ and n_{f} set to the first slot and the frame, respectively, used for the transmission of the repetition.

Modulation should be done using QPSK modulation scheme.

NPDSCH can be mapped to one or more than one subframes, N_{SF}, as given by clause 16.4.1.5 of 3GPP TS 36.213, each of which shall be transmitted NPDSCH Mᵣₑₚ^{NPDSCH} times.

For each of the antenna ports used for transmission of the physical channel, the block of complex-valued symbols y^{(p)}(0), . . . y^{(p)}(M_{symb}^{ap}−1) shall be mapped to resource elements (k, l) which meet all of the following criteria in the current subframe:

the subframe is not used for transmission of NPBCH, NPSS, or NSSS, and

they are assumed by the UE not to be used for NRS, and

they are not overlapping with resource elements used for CRS (if any), and

the index l in the first slot in a subframe fulfils 1≥l_{DataStart} where l_{DataStart} is given by clause 16.4.1.4 of 3GPP TS 36.213.

The mapping of y^{(p)}(0), . . . y^{(p)}(M_{symb}^{ap}−1) in sequence starting with y^{(p)}(0) to resource elements (k,l) on antenna port p meeting the criteria above shall be increasing order of the first the index k and the index l, starting with the first slot and ending with the second slot in a subframe. For NPDSCH not carrying BCCH, after mapping to a subframe, the subframe shall be repeated for Mᵣₑₚ^{NPDSCH}−1 additional subframes, before continuing the mapping of y^{(p)}(⋅) to the following subframe. The mapping of y^{(p)}(0), . . . y^{(p)}(M_{symb}^{ap}−1) is then repeated until Mᵣₑₚ^{NPDSCH}N_{SF} subframes have been transmitted. For NPDSCH carrying BCCH, the y^{(p)}(0), . . . y^{(p)}(M_{symb}^{ap}−1) is mapped to N_{SF} subframes in sequence and then repeated until Mᵣₑₚ^{NPDSCH}N_{SF} subframes have been transmitted.

The NPDSCH transmission can be configured by higher layers with transmission gaps where the NPSDCH transmission is postponed. There are no gaps in the NPDSCH transmission if Rₘₐₓ<N_{gap,threshold} where N_{gap,threshold} is given by the higher layer parameter dl-GapThreshold and Rₘₐₓ is given by 3GPP TS 36.213. The gap starting frame and subframe is given by (10n_{f}+└nₛ/2┘) mod N_{gap,period}=0 where the gap periodicity, N_{gap,period}, is given by the higher layer parameter dl-GapPeriodicity. The gap duration in number of subframes is given by N_{gap,duration}=N_{gap,coeff}N_{gap,period}, where N_{gap,coeff} is given by the higher layer parameter dl-GapDurationCoeff. For NPDSCH carrying the BCCH there are no gaps in the transmission.

The UE shall not expect NPDSCH in subframe i if it is not a NB-IoT downlink subframe, except for transmissions of NPDSCH carrying SystemInformationBlockType1-NB in subframe 4. In case of NPDSCH transmissions, in subframes that are not NB-IoT downlink subframes, the NPDSCH transmission is postponed until the next NB-IoT downlink subframe.

UE procedure for receiving the NPDSCH

A NB-IoT UE shall assume a subframe as a NB-IoT DL subframe if

the UE determines that the subframe does not contain NPSS/NSSS/NPBCH/NB-SIB1 transmission, and

for a NB-IoT carrier that a UE receives higher layer parameter operationModeInfo, the subframe is configured as NB-IoT DL subframe after the UE has obtained SystemInformationBlockType1-NB.

for a NB-IoT carrier that DL-CarrierConfigCommon-NB is present, the subframe is configured as NB-IoT DL subframe by the higher layer parameter downlinkBitmapNonAnchor.

For a NB-IoT UE that supports twoHARQ-Processes-r14, there shall be a maximum of 2 downlink HARQ processes.

A UE shall upon detection on a given serving cell of a NPDCCH with DCI format N1, N2 ending in subframe n intended for the UE, decode, starting in n+5 DL subframe, the corresponding NPDSCH transmission in N consecutive NB-IoT DL subframe(s) nᵢ with i=0,1, . . . , N−1 according to the NPDCCH information, where

subframe n is the last subframe in which the NPDCCH is transmitted and is determined from the starting subframe of NPDCCH transmission and the DCI subframe repetition number field in the corresponding DCI;

subframe(s) ni with i=0,1, . . . , N−1 are N consecutive NB-IoT DL subframe(s) excluding subframes used for SI messages where, n0<n1< . . . , nN−1 ,

N=N_{Rep}N_{SF}, where the value of N_{Rep} is determined by the repetition number field in the corresponding DCI, and the value of N_{SF} is determined by the resource assignment field in the corresponding DCI, and

k₀ is the number of NB-IoT DL subframe(s) starting in DL subframe n+5 until DL subframen₀, where k₀ is determined by the scheduling delay field (I_{Delay}) for DCI format N1, and k₀=0 for DCI format N2. For DCI CRC scrambled by G-RNTI, k₀ is determined by the scheduling delay field (I_{Delay}) according to Table 21, otherwise k₀ is determined by the scheduling delay field (I_{Delay}) according to Table 20. The value of R_{m,ax} is according to Subclause 16.6 in 3GPP 36.213 for the corresponding DCI format N1.

Table 20 shows an example of k0 for DCI format N1.

TABLE 20

k₀

| I_{Delay} | Rₘₐₓ < 128 | Rₘₐₓ ≥ 128 |
|---|---|---|
| 0 | 0 | 0 |
| 1 | 4 | 16 |
| 2 | 8 | 32 |
| 3 | 12 | 64 |
| 4 | 16 | 128 |
| 5 | 32 | 256 |
| 6 | 64 | 512 |
| 7 | 128 | 1024 |

Table 21 shows an example of k_0 for DCI format N1 with DCI CRC scrambled by G-RNTI.

TABLE 21

| I_{Delay} | k₀ |
|---|---|
| 0 | 0 |
| 1 | 4 |
| 2 | 8 |
| 3 | 12 |
| 4 | 16 |
| 5 | 32 |
| 6 | 64 |
| 7 | 128 |

A UE is not expected to receive transmissions in 3 DL subframes following the end of a NPUSCH transmission by the UE.

The resource allocation information in DCI format N1, N2 (paging) for NPDSCH indicates to a scheduled UE

Table 22 shows an example of the number of subframes for NPDSCH. A number of subframes (N_{SF}) determined by the resource assignment field (I_{SF}) in the corresponding DCI according to Table 22.

A repetition number (N_{Rep}) determined by the repetition number field (I_{Rep}) in the corresponding DCI according to Table 23.

TABLE 22

| I_{SF} | N_{SF} |
|---|---|
| 0 | 1 |
| 1 | 2 |
| 2 | 3 |
| 3 | 4 |
| 4 | 5 |
| 5 | 6 |
| 6 | 8 |
| 7 | 10 |

Table 23 shows an example of the number of repetitions for NPDSCH.

TABLE 23

| I_{REP} | N_{REP} |
|---|---|
| 0 | 1 |
| 1 | 2 |
| 2 | 4 |
| 3 | 8 |
| 4 | 16 |
| 5 | 32 |
| 6 | 64 |
| 7 | 128 |
| 8 | 192 |
| 9 | 256 |
| 10 | 384 |
| 11 | 512 |
| 12 | 768 |
| 13 | 1024 |
| 14 | 1536 |
| 15 | 2048 |

The number of repetitions for the NPDSCH carrying SystemInformationBlockType1-NB is determined based on the parameter schedulingInfoSIB1 configured by higher-layers and according to Table 24.

Table 24 shows an example of the number of repetitions for SIB1-NB.

TABLE 24

| Value of schedulingInfoSIB1 | Number of NPDSCH repetitions |
|---|---|
| 0 | 4 |
| 1 | 8 |
| 2 | 16 |
| 3 | 4 |
| 4 | 8 |
| 5 | 16 |
| 6 | 4 |
| 7 | 8 |
| 8 | 16 |
| 9 | 4 |
| 10 | 8 |
| 11 | 16 |
| 12-15 | Reserved |

The starting radio frame for the first transmission of the NPDSCH carrying SystemInformationBlockType1-NB is determined according to Table 25.

Table 25 shows an example of a start radio frame for the first transmission of the NPDSCH carrying SIB1-NB.

TABLE 25

| Number of | | Starting radio frame |
|---|---|---|
| NPDSCH | | number for NB-SIB1 |
| repetitions | N_{ID}^{Ncell} | repetitions (nf mod 256) |
| 4 | N_{ID}^{Ncell} mod 4 = 0 | 0 |
| | N_{ID}^{Ncell} mod 4 = 1 | 16 |
| | N_{ID}^{Ncell} mod 4 = 2 | 32 |
| | N_{ID}^{Ncell} mod 4 = 3 | 48 |
| 8 | N_{ID}^{Ncell} mod 2 = 0 | 0 |
| | N_{ID}^{Ncell} mod 2 = 1 | 16 |
| 16 | N_{ID}^{Ncell} mod 2 = 0 | 0 |
| | N_{ID}^{Ncell} mod 2 = 1 | 1 |

The starting OFDM symbol for NPDSCH is given by index l_{DataStrart} in the first slot in a subframe k and is determined as follows

if subframe k is a subframe used for receiving SIB1-NB,

l_{Datastrart}=3 if the value of the higher layer parameter operationModeInfo is set to ‘00’ or ‘01’

l_{DataStrart}=0 otherwise

else

l_{Datastrart} is given by the higher layer parameter eutraControlRegionSize if the value of the higher layer parameter eutraControlRegionSize is present

l_{DataStrart}=0 otherwise

UE Procedure for Reporting ACK/NACK

The UE shall upon detection of a NPDSCH transmission ending in NB-IoT subframe n intended for the UE and for which an ACK/NACK shall be provided, start, at the end of n+k₀−1 DL subframe transmission of the NPUSCH carrying ACK/NACK response using NPUSCH format 2 in N consecutive NB-IoT UL slots, where N=N_{Rep}^{AN}Nₛₗₒₜₛ^{UL}, where the value of N_{Rep}^{AN} is given by the higher layer parameter ack-NACK-NumRepetitions-Msg4 configured for the associated NPRACH resource for Msg4 NPDSCH transmission, and higher layer parameter ack-NACK-NumRepetitions otherwise, and the value of Nₛₗₒₜₛ^{UL} is the number of slots of the resource unit,

allocated subcarrier for ACK/NACK and value of k0 is determined by the ACK/NACK resource field in the DCI format of the corresponding NPDCCH according to Table 16.4.2-1, and Table 16.4.2-2 in 3GPP TS36.213.

Narrowband Physical Broadcast Channel (NPBCH)

The processing structure for the BCH transport channel is according to Section 5.3.1 of 3GPP TS 36.212, with the following differences:

The transmission time interval (TTI) is 640 ms.

The size of the BCH transport block is set to 34 bits

The CRC mask for NPBCH is selected according to 1 or 2 transmit antenna ports at eNodeB according to Table 5.3.1.1-1 of 3GPP TS 36.212, where the transmit antenna ports are defined in section 10.2.6 of 3GPP TS 36.211

The number of rate matched bits is defined in section 10.2.4.1 of 3GPP TS 36.211

Scrambling shall be done according to clause 6.6.1 of 3GPP TS 36.211 with M_{bit} denoting the number of bits to be transmitted on the NPBCH. M_{bit} equals 1600 for normal cyclic prefix. The scrambling sequence shall be initialized with cᵢₙᵢₜ=N_{ID}^{Ncell} in radio frames fulfilling n_{f} mod 64=0.

Modulation should be done using QPSK modulation scheme for each antenna port is transmitted in subframe 0 during 64 consecutive radio frames starting in each radio frame fulfilling n_{f} mod 64 =0 and shall

Layer mapping and precoding shall be done according to clause 6.6.3 of 3GPP TS 36.211 with P ∈ {1,2}. The UE shall assume antenna ports R₂₀₀₀ and R₂₀₀₁ are used for the transmission of the narrowband physical broadcast channel.

The block of complex-valued symbols y^{(p)}(0), . . . y^{(p)}(M_{symb}−1) for each antenna port is transmitted in subframe 0 during 64 consecutive radio frames starting in each radio frame fulfilling n_{f} mod 64=0 and shall be mapped in sequence starting consecutive radio frames starting with y(0) to resource elements (k,l) not reserved for transmission of reference signals shall be in increasing order of the first the index k, then the index l. After mapping to a subframe, the subframe shall be repeated in subframe 0 in the 7 following radio frames, before continuing the mapping of y^{(p)}(⋅) to subframe 0 in the following radio frame. The first three OFDM symbols in a subframe shall not be used in the mapping process. For the purpose of the mapping, the UE shall assume cell-specific reference signals for antenna ports 0-3 and narrowband reference signals for antenna ports 2000 and 2001 being present irrespective of the actual configuration. The frequency shift of the cell-specific reference signals shall be calculated by replacing cell N_{ID}^{cell} with N_{ID}^{Ncell} in the calculation of v_{shift} in clause 6.10.1.2 of 3GPP TS 36.211.

Narrowband Physical Downlink Control Channel (NPDCCH)

The narrowband physical downlink control channel carries control information. A narrowband physical control channel is transmitted on an aggregation of one or two consecutive narrowband control channel elements (NCCEs), where a narrowband control channel element corresponds to 6 consecutive subcarriers in a subframe where NCCE 0 occupies subcarriers 0 through 5 and NCCE 1 occupies subcarriers 6 through 11. The NPDCCH supports multiple formats as listed in Table 26. For NPDCCH format 1, both NCCEs belong to the same subframe. One or two NPDCCHs can be transmitted in a subframe.

Table 26 shows an example of supported NPDCCH formats.

TABLE 26

| NPDCCH format | Number of NCCEs |
|---|---|
| 0 | 1 |
| 1 | 2 |

Scrambling shall be done according to clause 6.8.2 of TS36.211. The scrambling sequence shall be initialized at the start of subframe k₀ according to section 16.6 of TS36.213 after every 4th NPDCCH subframe with cᵢₙᵢₜ=└nₛ/2┘2⁹+N_{ID}^{Ncell} where nₛ is the first slot of the NPDCCH subframe in which scrambling is (re-)initialized.

Modulation shall be done according to clause 6.8.3 of TS36.211 using the QPSK modulation scheme.

Layer mapping and precoding shall be done according to clause 6.6.3 of TS36.211 using the same antenna ports as the NPBCH.

The block of complex-valued symbols y(0), . . . y(M_{symb}−1) shall be mapped in sequence starting with y(0) to resource elements (k,l) on the associated antenna port which meet all of the following criteria:

they are part of the NCCE(s) assigned for the NPDCCH transmission, and

they are not used for transmission of NPBCH, NPSS, or NSSS, and

they are assumed by the UE not to be used for NRS, and

they are not overlapping with resource elements used for PBCH, PSS, SSS, or CRS as defined in clause 6 of TS36.211 (if any), and

the index l in the first slot in a subframe fulfils l≥l_{NPDCCHStart} where l_{NPDCCHStart} is given by clause 16.6.1 of 3GPP TS 36.213.

The mapping to resource elements (k,l) on antenna port p meeting the criteria above shall be in increasing order of first the index k and then the index l, starting with the first slot and ending with the second slot in a subframe.

The NPDCCH transmission can be configured by higher layers with transmissions gaps where the NPDCCH transmission is postponed. The configuration is the same as described for NPDSCH in clause 10.2.3.4 of TS36.211.

The UE shall not expect NPDCCH in subframe i if it is not a NB-IoT downlink subframe. In case of NPDCCH transmissions, in subframes that are not NB-IoT downlink subframes, the NPDCCH transmission is postponed until the next NB-IoT downlink subframe.

DCI Dormat

DCI Format N0

DCI format N0 is used for the scheduling of NPUSCH in one UL cell. The following information is transmitted by means of the DCI format N0:

Flag for format N0/format N1 differentiation (1 bit), Subcarrier indication (6 bits), Resource assignment (3 bits), Scheduling delay (2 bits), Modulation and coding scheme (4 bits), Redundancy version (1 bit), Repetition number (3 bits), New data indicator (1 bit), DCI subframe repetition number (2 bits)

DCI Format N1

DCI format N1 is used for the scheduling of one NPDSCH codeword in one cell and random access procedure initiated by a NPDCCH order. The DCI corresponding to a NPDCCH order is carried by NPDCCH. The following information is transmitted by means of the DCI format N1:

Flag for format N0/format N1 differentiation (1 bit), NPDCCH order indicator (1 bit)

Format N1 is used for random access procedure initiated by a NPDCCH order only if NPDCCH order indicator is set to “1”, format N1 CRC is scrambled with C-RNTI, and all the remaining fields are set as follows:

Starting number of NPRACH repetitions (2 bits), Subcarrier indication of NPRACH (6 bits), All the remaining bits in format N1 are set to one.

Otherwise,

Scheduling delay (3 bits), Resource assignment (3 bits), Modulation and coding scheme (4 bits), Repetition number (4 bits), New data indicator (1 bit), HARQ-ACK resource (4 bits), DCI subframe repetition number (2 bits)

When the format N1 CRC is scrambled with a RA-RNTI, then the following fields among the fields above are reserved:

New data indicator, HARQ-ACK resource

If the number of information bits in format N1 is less than that of format NO, zeros shall be appended to format N1 until the payload size equals that of format N0.

DCI Format N2

DCI format N2 is used for for paging and direct indication. The following information is transmitted by means of the DCI format N2.

Flag for paging/direct indication differentiation (1 bit)

If Flag=0:

Direct Indication information (8 bits), Reserved information bits are added until the size is equal to that of format N2 with Flag=1

If Flag=1:

Resource assignment (3 bits), Modulation and coding scheme (4 bits), Repetition number (4 bits), DCI subframe repetition number (3 bits)

NPDCCH Related Procedure

A UE shall monitor a set of NPDCCH candidates as configured by higher layer signalling for control information, where monitoring implies attempting to decode each of the NPDCCHs in the set according to all the monitored DCI formats.

An NPDCCH search space NSₖ^{(L′,R)} at aggregation level L′ ∈ {1,2} and repetition level R ∈ {1,2,4,8,16,32,64,128,256,512,1024,2048} is defined by a set of NPDCCH candidates where each candidate is repeated in a set of R consecutive NB-IoT downlink subframes excluding subframes used for transmission of SI messages starting with subframe k.

The locations of starting subframe k are given by k=k_{b} where k_{b} is the b^{th} consecutive NB-IoT DL subframe from subframe k0, excluding subframes used for transmission of SI messages, and b=u·R, and

$$u = 0 , 1 , … , \frac{{R}_{max}}{R} - 1 ,$$

and where subframe k0 is a subframe satisfying the condition (10n_{f}+└nₛ/2┘ mod T)=└a_{offset}·T┘, where T=Rₘₐₓ·G, T≥4. G and a_{offset} are given by the higher layer parameters.

For Type1-NPDCCH common search space, k=k0 and is determined from locations of NB-IoT paging opportunity subframes.

If the UE is configured by high layers with a NB-IoT carrier for monitoring of NPDCCH UE-specific search space,

the UE shall monitor the NPDCCH UE-specific search space on the higher layer configured NB-IoT carrier,

the UE is not expected to receive NPSS, NSSS, NPBCH on the higher layer configured NB-IoT carrier.

otherwise,

the UE shall monitor the NPDCCH UE-specific search space on the same NB-IoT carrier on which NPSS/NSSS/NPBCH are detected.

The starting OFDM symbol for NPDCCH given by index l_{NPDCCHStart} in the first slot in a subframe k and is determined as follows

if higher layer parameter eutraControlRegionSize is present

l_{NPDCCHStart} is given by the higher layer parameter eutraControlRegionSize

Otherwise, l_{NPDCCHStart}=0

Narrowband Reference Signal (NRS)

Before a UE obtains operationModeInfo, the UE may assume narrowband reference signals are transmitted in subframes #0 and #4 and in subframes #9 not containing NSSS.

When UE receives higher-layer parameter operationModeInfo indicating guardband or standalone,

Before the UE obtains SystemInformationBlockType1-NB, the UE may assume narrowband reference signals are transmitted in subframes #0, #1, #3, #4 and in subframes #9 not containing NSSS.

After the UE obtains SystemInformationBlockType1-NB, the UE may assume narrowband reference signals are transmitted in subframes #0, #1, #3, #4, subframes #9 not containing NSSS, and in NB-IoT downlink subframes and shall not expect narrowband reference signals in other downlink subframes.

When UE receives higher-layer parameter operationModeInfo indicating inband-SamePCI or inband-DifferentPCI,

Before the UE obtains SystemInformationBlockType1-NB, the UE may assume narrowband reference signals are transmitted in subframes #0, #4 and in subframes #9 not containing NSSS.

After the UE obtains SystemInformationBlockType1-NB, the UE may assume narrowband reference signals are transmitted in subframes #0, #4, subframes #9 not containing NSSS, and in NB-IoT downlink subframes and shall not expect narrowband reference signals in other downlink subframes.

Narrowband Primary Synchronization Signal (NPSS)

The sequence dₗ(n) used for the narrowband primary synchronization signal is generated from a frequency-domain Zadoff-Chu sequence according to Equation 17 below.

$${d}_{l} ( n ) = S ( l ) \cdot {e}^{- j \frac{π u n ( n + 1 )}{11}} , n = 0 , 1 , … , 10 \qquad [ Equation 17 ]$$

where the Zadoff-Chu root sequence index u=5 and S(l) for different symbol indices l is given by Table 27.

Table 27 shows an example of S(l).

TABLE 27

| Cyclic prefix length | S(3), . . . , S(13) | | | | | | | | | | |
|---|---|---|---|---|---|---|---|---|---|---|---|
| Normal | 1 | 1 | 1 | 1 | −1 | −1 | 1 | 1 | 1 | −1 | 1 |

The same antenna port shall be used for all symbols of the narrowband primary synchronization signal within a subframe.

UE shall not assume that the narrowband primary synchronization signal is transmitted on the same antenna port as any of the downlink reference signals. The UE shall not assume that the transmissions of the narrowband primary synchronization signal in a given subframe use the same antenna port, or ports, as the narrowband primary synchronization signal in any other subframe.

The sequences dₗ(n) shall be mapped to resource elements (k,l) in increasing order of first the index k=0, 1, . . . , N_{sc}^{RB}−2 and then the index l=3,4, . . . , 2N_{symb}^{DL}−1 in subframe 5 in every radio frame. For resource elements (k, I) overlapping with resource elements where cell-specific reference signals are transmitted, the corresponding sequence element d(n) is not used for the NPSS but counted in the mapping process.

Narrowband Secondary Synchronization Signals (NSSS)

The sequence d(n) used for the narrowband secondary synchronization signal is generated from a frequency-domain Zadoff-Chu sequence according to Equation 18 below.

$$d ( n ) = {b}_{q} ( n ) \cdot {e}^{- j 2 π {θ}_{f} n} \cdot {e}^{- j \frac{π {un}^{′} ( {n}^{′} + 1 )}{131}} \\ where \\ n = 0 , 1 , … , 131 \\ {n}^{′} = n mod 131 \\ m = n mod 128 \\ u = {N}_{ID}^{N c e l l} mod 126 + 3 \\ q = ⌊ \frac{{N}_{ID}^{N c e l l}}{126} ⌋ \qquad [ Equation 18 ]$$

The binary sequence b_{q}(n) is given by Table 28. The cyclic shift θ_{f} in frame number n_{f} is given by

$${θ}_{f} = \frac{33}{132} ( {n}_{f} / 2 ) mod 4.$$

Table 28 shows an example of b_{q}(n)

TABLE 28

| q | b_{q} (0), . . . , b_{q} (127) |
|---|---|
| 0 | [1 1 1 1 1 1 1 1 1 1 1 1 1 1 1 1 1 1 1 1 1 1 1 1 1 1 1 1 1 1 |
| | 1 1 1 1 1 1 1 1 1 1 1 1 1 1 1 1 1 1 1 1 1 1 1 1 1 1 1 1 1 1 1 1 1 |
| | 1 1 1 1 1 1 1 1 1 1 1 1 1 1 1 1 1 1 1 1 1 1 1 1 1 1 1 1 1 1 1 1 1 |
| | 1 1 1 1 1 1 1 1 1 1 1 1 1 1 1 1 1 1 1 1 1 1 1 1 1 1 1 1 1 1 1 1] |
| 1 | [1 −1 −1 1 −1 1 1 −1 −1 1 1 −1 1 −1 −1 1 −1 1 1 −1 1 −1 −1 |
| | 1 1 −1 −1 1 −1 1 1 −1 1 −1 −1 1 −1 1 1 −1 −1 1 1 −1 1 −1 −1 |
| | 1 −1 1 1 −1 1 −1 −1 1 1 −1 −1 1 −1 1 1 −1 1 −1 −1 1 −1 1 |
| | 1 −1 −1 1 1 −1 1 −1 −1 1 −1 1 1 −1 1 −1 −1 1 1 −1 −1 1 −1 |
| | 1 1 −1 1 −1 −1 1 −1 1 1 −1 −1 1 1 −1 1 −1 −1 1 −1 1 1 −1 |
| | 1 −1 −1 1 1 −1 −1 1 −1 1 1 −1] |
| 2 | [1 −1 −1 1 −1 1 1 −1 −1 1 1 −1 1 −1 −1 1 −1 1 1 −1 1 −1 −1 |
| | 1 1 −1 −1 1 −1 1 1 −1 −1 1 1 −1 1 −1 −1 1 1 −1 −1 1 −1 1 |
| | 1 −1 1 −1 −1 1 −1 1 1 −1 −1 1 1 −1 1 −1 −1 1 1 −1 −1 1 −1 1 |
| | 1 −1 −1 1 1 −1 1 −1 −1 1 −1 1 1 −1 1 −1 −1 1 1 −1 −1 1 −1 |
| | 1 1 −1 −1 1 1 −1 1 −1 −1 1 1 −1 −1 1 −1 1 1 −1 1 −1 −1 1 −1 |
| | 1 1 −1 −1 1 1 −1 1 −1 −1 1] |
| 3 | [1 −1 −1 1 −1 1 1 −1 −1 1 1 −1 1 −1 −1 1 −1 1 1 −1 1 −1 −1 |
| | 1 1 −1 −1 1 −1 1 1 −1 −1 1 1 −1 1 −1 −1 1 1 −1 −1 1 −1 1 |
| | 1 −1 1 −1 −1 1 −1 1 1 −1 −1 1 1 −1 1 −1 −1 1 −1 1 1 −1 1 −1 −1 |
| | 1 1 −1 −1 1 −1 1 1 −1 1 −1 −1 1 −1 1 1 −1 −1 1 1 −1 1 −1 −1 |
| | 1 1 −1 −1 1 −1 1 1 −1 −1 1 1 −1 1 −1 −1 1 −1 1 1 −1 |
| | 1 −1 −1 1 1 −1 −1 1 −1 1 1 −1] |

The same antenna port shall be used for all symbols of the narrowband secondary synchronization signal within a subframe.

UE shall not assume that the narrowband secondary synchronization signal is transmitted on the same antenna port as any of the downlink reference signals. The UE shall not assume that the transmissions of the narrowband secondary synchronization signal in a given subframe use the same antenna port, or ports, as the narrowband secondary synchronization signal in any other subframe.

The sequence d(n) shall be mapped to resource elements (k,l) in sequence starting with d(0) in increasing order of the first the index k over the 12 assigned subcarriers and then the index l over the assigned last N_{symb}^{NSSS}, symbols of subframe 9 in radio frames fulfilling n_{f} mod 2=0, where N_{symb}^{NSSS} is given by Table 29.

Table 29 shows an example of the number of NSSS symbols.

TABLE 29

| Cyclic prefix length | N_{symb}^{NSSS} |
|---|---|
| Normal | 11 |

OFDM Baseband Signal Generation

If the higher layer parameter operationModeInfo does not indicate ‘inband-SamePCI’ and samePCI-Indicator does not indicate ‘samePCI’, then the time-continuous signal sₗ^{(p)}(t) on antenna port p in OFDM symbol l in a downlink slot is defined by Equation 19 below.

$${s}_{l}^{( p )} ( t ) = {\sum }_{k = - ⌊ {N}_{sc}^{RB} / 2 ⌋}^{⌈ {N}_{sc}^{RB} / 2 ⌋ - 1} {a}_{{k}^{( - )} , l}^{( p )} \cdot {e}^{j 2 π ( k + \frac{1}{2} ) Δ f ( t - {N}_{CP , i} {T}_{s} )} \qquad [ Equation 19 ]$$

for 0≤t<(N_{CP,i}+N)×Tₛ where k⁽⁻⁾=k+└N_{sc}^{RB}/2┘, N=2048, Δf=15 kHz and a_{k,l}^{(p)} is the content of resource element (k,l) on antenna port p.

If the higher layer parameter operationModeInfo indicates ‘inband-SamePCI’ or samePCI-Indicator indicate ‘samePCI’, then the time-continuous signal sₗ^{(p)}(t) on antenna port p in OFDM symbol l′ , where l′=1+N_{symb}^{DL}(nₛ mod 4) ∈ {0, . . . , 27} is the OFDM symbol index from the start of the last even-numbered subframe, is defined by Equation 20 below.

$${s}_{l}^{( p )} ( t ) = {\sum }_{k = - ⌊ {N}_{RB}^{DL} {N}_{sc}^{RB} / 2 ⌋}^{- 1} {e}^{{θ}_{{k}^{( - )}}} {a}_{{k}^{( - )} , l}^{( p )} \cdot {e}^{j 2 π k Δ f ( t - {N}_{CP , {l}^{′} mod {N}_{symb}^{DL} {T}_{s}} )} + {\sum }_{k = 1}^{⌈ {N}_{RB}^{DL} {N}_{sc}^{RB} / 2 ⌉} {e}^{{θ}_{{k}^{( + )}}} {a}_{{k}^{( + )} , l}^{( p )} \cdot {e}^{j 2 π k Δ f ( t - {N}_{CP , {l}^{′} mod {N}_{symb}^{DL} {T}_{s}} )} \qquad [ Equation 20 ]$$

for 0≤t<(N_{CP,i}+N)×Tₛ where k⁽⁻⁾=k+└N_{RB}^{DL}N_{sc}^{RB}/2┘ and K⁽⁺⁾=k+└N_{RB}^{DL}N_{sc}^{RB}/2┘−1, θ_{k,l′}=j2πf_{NB-IoT}Tₛ(N+Σᵢ₌₀^{l′}N_{CP,i mod 7}) if resource element (k,l′) is used for Narrowband IoT, and 0 otherwise, and f_{NB-IoT} is the frequency location of the carrier of the Narrowband IoT PRB minus the frequency location of the center of the LTE signal.

Only normal CP is supported for Narrowband IoT downlink in this release of the specification.

Hereinafter, the physical layer process of the narrowband physical broadcast channel (NPBCH) will be described in more detail.

Scrambling

Scrambling shall be done according to clause 6.6.1 with M_{bit} denoting the number of bits to be transmitted on the NPBCH. M_{bit} equals 1600 for normal cyclic prefix. The scrambling sequence shall be initialised with cᵢₙᵢₜ=N_{ID}^{Ncell} in radio frames fulfilling n_{f} mod 64=0.

Modulation

Modulation shall be done according to clause 6.6.2 using the modulation scheme in Table 10.2.4.2-1.

Table 30 shows an example of a modulation scheme for NPBCH.

TABLE 30

| Physical channel | Modulation schemes |
|---|---|
| NPBCH | QPSK |

Layer Mapping and Precoding

Layer mapping and precoding shall be done according to clause 6.6.3 with P ∈ {1,2}. The UE shall assume antenna ports R₂₀₀₀ and R₂₀₀₁ are used for the transmission of the narrowband physical broadcast channel.

Mapping to Resource Elements

The block of complex-valued symbols y^{(p)}(0), . . . , y^{(p)}(M_{symb}−1) for each antenna port is transmitted in subframe 0 during 64 consecutive radio frames starting in each radio frame fulfilling n_{f} mod 64=0 and shall be mapped in sequence starting with y(0) to resource elements (k,l). The mapping to resource elements (k,l) not reserved for transmission of reference signals shall be in increasing order of first the index k, then the index l. After mapping to a subframe, the subframe shall be repeated in subframe 0 in the 7 following radio frames, before continuing the mapping of y^{(p)}(⋅) to subframe 0 in the following radio frame. The first three OFDM symbols in a subframe shall not be used in the mapping process.

For the purpose of the mapping, the UE shall assume cell-specific reference signals for antenna ports 0-3 and narrowband reference signals for antenna ports 2000 and 2001 being present irrespective of the actual configuration. The frequency shift of the cell-specific reference signals shall be calculated by replacing N_{ID}^{cell} with N_{ID}^{Ncell} in the calculation of v_{shift} in clause 6.10.1.2.

Next, information related to MIB-NB and SIBN1-NB will be described in more detail.

MasterInformationBlock-NB

The MasterInformationBlock-NB includes the system information transmitted on BCH.

Signalling radio bearer: N/A

RLC-SAP: TM

Logical channel: BCCH

Direction: E-UTRAN to UE

Table 31 shows an example of the MasterInformationBlock-NB format.

TABLE 31
-- ASN1START

| | |
|---|---|
| MasterInformationBlock-NB ::= | SEQUENCE { |

| | |
|---|---|
| systemFrameNumber-MSB-r13 | BIT STRING (SIZE (4)), |
| hyperSFN-LSB-r13 | BIT STRING (SIZE (2)), |
| schedulingInfoSIB1-r13 | INTEGER (0..15), |
| systemInfoValueTag-r13 | INTEGER (0..31), |
| ab-Enabled-r13 | BOOLEAN, |
| operationModeInfo-r13 | CHOICE { |

| | |
|---|---|
| inband-SamePCI-r13 | Inband-SamePCI-NB-r13, |
| inband-Different PCI-r13 | Inband-Different PCI-NB-r13, |
| guardband-r13 | Guardband-NB-r13, |
| standalone-r13 | Standalone-NB-r13 |

| }, | |
|---|---|
| spare | BIT STRING (SIZE (11)) |

}
ChannelRasterOffset-NB-r13 ::= ENUMERATED {khz-7dot5, khz-2dot5, khz2dot5,
khz7dot5}

| | |
|---|---|
| Guardband-NB-r13 ::= | SEQUENCE { |

| | |
|---|---|
| rasterOffset-r13 | ChannelRasterOffset-NB-r13, |
| spare | BIT STRING (SIZE (3)) |

}

| | |
|---|---|
| Inband-SamePCI-NB-r13 ::= | SEQUENCE { |

| | |
|---|---|
| eutra-CRS-SequenceInfo-r13 | INTEGER (0..31) |

}

| | |
|---|---|
| Inband-Different PCI-NB-r13 ::= | SEQUENCE { |

| | |
|---|---|
| eutra-NumCRS-Ports-r13 | ENUMERATED {same, four}, |
| rasterOffset-r13 | ChannelRasterOffset-NB-r13, |
| spare | BIT STRING (SIZE (2)) |

}

| | |
|---|---|
| Standalone-NB-r13 ::= | SEQUENCE { |

| | |
|---|---|
| spare | BIT STRING (SIZE (5)) |

}
-- ASN1STOP

Table 32 shows the description of the MasterInformationBlock-NB field.

TABLE 32
MasterInformationBlock-NB field descriptions

ab-Enabled
Value TRUE indicates that access barring is enabled and that the UE shall
acquire SystemInformationBlockType14-NB before initiating RRC
connection establishment or resume.
eutra-CRS-SequenceInfo
Information of the carrier containing NPSS/NSSS/NPBCH.
Each value is associated with an E-UTRA PRB index as an offset
from the middle of the LTE system sorted out by channel raster offset.
eutra-NumCRS-Ports
Number of E-UTRA CRS antenna ports, either the same number of ports
as NRS or 4 antenna ports.
hyperSFN-LSB
Indicates the 2 least significant bits of hyper SFN. The remaining bits are
present in SystemInformationBlockType1-NB.
operationModeInfo
Deployment scenario (in-band/guard-band/standalone) and related
information. See TS 36.211 [21] and TS 36.213 [23].
Inband-SamePCI indicates an in-band deployment and that the NB-IoT
and LTE cell share the same physical cell id and have the same number
of NRS and CRS ports.
Inband-DifferentPCI indicates an in-band deployment and that the NB-IoT
and LTE cell have different physical cell id.
guardband indicates a guard-band deployment.
standalone indicates a standalone deployment.
rasterOffset
NB-IoT offset from LTE channel raster. Unit in kHz in set {−7.5, −2.5,
2.5, 7.5}
schedulingInfoSIB1
This field contains an index to a table specified in TS 36.213 [23, Table
16.4.1.3-3] that defines SystemInformationBlockType1-NB scheduling
information.
systemFrameNumber-MSB
Defines the 4 most significant bits of the SFN. As indicated in TS 36.211
[21], the 6 least significant bits of the SFN are acquired implicitly
by decoding the NPBCH.
systemInfoValueTag
Common for all SIBs other than MIB-NB, SIB14-NB and SIB16-NB.

SystemInformationBlockType1-NB

The SystemInformationBlockType1-NB message contains information relevant when evaluating if a UE is allowed to access a cell and defines the scheduling of other system information.

Signalling radio bearer: N/A

RLC-SAP: TM

Logical channel: BCCH

Direction: E-UTRAN to UE

Table 33 shows an example of a SystemInformationBlockType1 (SIB1)-NB message.

TABLE 33
-- ASN1START

| | |
|---|---|
| SystemInformationBlockType1-NB ::= | SEQUENCE { |

| | |
|---|---|
| hyperSFN-MSB-r13 | BIT STRING (SIZE (8)), |
| cellAccessRelatedInfo-r13 | SEQUENCE { |

| | |
|---|---|
| plmn-IdentityList-r13 | PLMN-IdentityList-NB-r13, |
| trackingAreaCode-r13 | TrackingAreaCode, |
| cellIdentity-r13 | CellIdentity, |
| cellBarred-r13 | ENUMERATED {barred, notBarred}, |
| intraFreqReselection-r13 | ENUMERATED {allowed, notAllowed} |

| }, | |
|---|---|
| cellSelectionInfo-r13 | SEQUENCE { |

| | |
|---|---|
| q-RxLevMin-r13 | Q-RxLevMin, |
| q-QualMin-r13 | Q-QualMin-r9 |

| }, | | | |
|---|---|---|---|
| p-Max-r13 | P-Max | OPTIONAL, | -- Need OP |

| freqBandIndicator-r13 | FreqBandIndicator-NB-r13 | | |
|---|---|---|---|
| freqBandInfo-r13 | NS-PmaxList-NB-r13 | OPTIONAL, | -- |

Need OR

| | | | |
|---|---|---|---|
| multiBandInfoList-r13 | MultiBandInfoList-NB-r13 | OPTIONAL, | -- |

Need OR

| | | | |
|---|---|---|---|
| downlinkBitmap-r13 | DL-Bitmap-NB-r13 | OPTIONAL, | -- |

Need OP,

| | | | |
|---|---|---|---|
| eutraControlRegionSize-r13 | ENUMERATED {n1, n2, n3} | OPTIONAL, | -- |

Cond inband

| | | |
|---|---|---|
| nrs-CRS-PowerOffset-r13 | ENUMERATED {dB-6, | dB-4dot77, dB-3, |

| | |
|---|---|
| dB-1dot77, dB0, | dB1, |

| dB1dot23, dB2, | | dB3, |
|---|---|---|
| dB4, | dB4dot23, | dB5, |
| dB6, | dB7, | dB8, |

| | | |
|---|---|---|
| dB9} | OPTIONAL, | -- Cond |

inband-SamePCI

| | |
|---|---|
| schedulingInfoList-r13 | SchedulingInfoList-NB-r13, |
| si-WindowLength-r13 | ENUMERATED {ms160, ms320, ms480, ms640, |

ms960, ms1280, ms1600, spare1},

| | | | |
|---|---|---|---|
| si-RadioFrameOffset-r13 | INTEGER (1..15) | OPTIONAL, | -- Need OP |

| | | | |
|---|---|---|---|
| systemInfoValueTagList-r13 | SystemInfoValueTagList-NB-r13 | OPTIONAL, | -- |

Need OR

| | | |
|---|---|---|
| lateNonCriticalExtension | OCTET STRING | OPTIONAL, |
| nonCriticalExtension | SEQUENCE { } | OPTIONAL |

}

| | |
|---|---|
| PLMN-IdentityList-NB-r13 ::= | SEQUENCE (SIZE (1..maxPLMN-r11)) OF PLMN- |

IdentityInfo-NB-r13

| | |
|---|---|
| PLMN-IdentityInfo-NB-r13 ::= | SEQUENCE { |

| plmn-Identity-r13 | PLMN-Identity, | | |
|---|---|---|---|
| cellReservedForOperatorUse-r13 | ENUMERATED {reserved, notReserved}, | | |
| attachWithoutPDN-Connectivity-r13 | ENUMERATED {true} | OPTIONAL | -- Need OP |

}
SchedulingInfoList-NB-r13 ::= SEQUENCE (SIZE(1..maxSI-Message-NB-r13)) OF
SchedulingInfo-NB-r13

| | |
|---|---|
| SchedulingInfo-NB-r13::= | SEQUENCE { |

| | |
|---|---|
| si-Periodicity-r13 | ENUMERATED {rf64, rf128, rf256, rf512, |

rf1024, rf2048, rf4096, spare},

| | |
|---|---|
| si-RepetitionPattern-r13 | ENUMERATED {every2ndRF, every4thRF, |

every8thRF, every16thRF},

| | |
|---|---|
| sib-MappingInfo-r13 | SIB-MappingInfo-NB-r13, |

| | |
|---|---|
| si-TB-r13 | ENUMERATED {b56, b120, b208, b256, b328, b440, b552, b680} |

}

| | |
|---|---|
| SystemInfoValueTagList-NB-r13 ::= | SEQUENCE (SIZE (1.. maxSI-Message-NB-r13)) OF |

SystemInfoValueTagSI-r13

| | |
|---|---|
| SIB-MappingInfo-NB-r13 ::= | SEQUENCE (SIZE (0..maxSIB-1)) OF SIB-Type-NB-r13 |
| SIB-Type-NB-r13 ::= | ENUMERATED { |

sibType3-NB-r13, sibType4-NB-r13, sibType5-NB-

r13,

sibType14-NB-r13, sibType16-NB-r13, spare3,

spare2, spare1}
-- ASN1STOP

Table 34 shows the description of the SystemInformationBlockType1-NB field.

TABLE 34
SystemInformationBlockType1-NB field descriptions

attachWithoutPDN-Connectivity
If present, the field indicates that attach without PDN connectivity as
specified in TS 24.301 [35] is supported for this PLMN.
cellBarred
Barred means the cell is barred, as defined in TS 36.304 [4].
cellIdentity
Indicates the cell identity.
cellReservedForOperatorUse
As defined in TS 36.304 [4].
cellSelectionInfo
Cell selection information as specified in TS 36.304 [4].
downlinkBitmapNB-IoT downlink subframe configuration for downlink
transmission.
If the bitmap is not present, the UE shall assume that all subframes are
valid (except for subframes carrying NPSS/NSSS/NPBCH/SIB1-NB) as
specified in TS 36.213[23].
eutraControlRegionSize
Indicates the control region size of the E-UTRA cell for the in-band
operation mode. Unit is in number of OFDM symbols.
freqBandIndicator
A list of as defined in TS 36.101 [42, table 6.2.4-1] for the frequency
band in freqBandIndicator.
freqBandInfo
A list of additionalPmax and additionalSpectrumEmission values as
defined in TS 36.101 [42, table 6.2.4-1] for the frequency band in
freqBandIndicator.
hyperSFN-MSB
Indicates the 8 most significat bits of hyper-SFN. Together with
hyperSFN-LSB in MIB-NB, the complete hyper-SFN is built up. hyper-
SFN is incremented by one when the SFN wraps around.
intraFreqReselection
Used to control cell reselection to intra-frequency cells when the highest
ranked cell is barred, or treated as barred by the UE, as specified in TS
36.304 [4].
multiBandInfoList
A list of additional frequency band indicators, additionalPmax and
additionalSpectrumEmission values, as defined in TS 36.101 [42, table
5.5-1]. If the UE supports the frequency band in the freqBandIndicator IE
it shall apply that frequency band. Otherwise, the UE shall apply the first
listed band which it supports in the multiBandInfoList IE.
nrs-CRS-PowerOffset
NRS power offset between NRS and E-UTRA CRS. Unit in dB. Default
value of 0.
plmn-IdentityList
List of PLMN identities. The first listed PLMN-Identity is the primary
PLMN.
p-Max
Value applicable for the cell. If absent the UE applies the maximum power
according to the UE capability.
q-QualMin
Parameter “Qqualmin” in TS 36.304 [4].
q-RxLevMin
Parameter Qrxlevmin in TS 36.304 [4]. Actual value Qrxlevmin = IE
value * 2 [dB].
schedulingInfoList
Indicates additional scheduling information of SI messages.
si-Periodicity
Periodicity of the SI-message in radio frames, such that rf256 denotes 256
radio frames, rf512 denotes 512 radio frames, and so on.
si-RadioFrameOffset
Offset in number of radio frames to calculate the start of the SI window.
If the field is absent, no offset is applied.
si-RepetitionPattern
Indicates the starting radio frames within the SI window used for SI
message transmission. Value every2ndRF corresponds to every second
radio frame, value every4thRF corresponds to every fourth radio frame
and so on starting from the first radio frame of the SI window used
for SI transmission.
si-TB
This field indicates the transport block size in number of bits used to
broadcast the SI message.
si-WindowLength
Common SI scheduling window for all SIs. Unit in milliseconds, where
ms160 denotes 160 milliseconds, ms320 denotes 320 milliseconds and so
on.
sib-MappingInfo
List of the SIBs mapped to this SystemInformation message. There is no
mapping information of SIB2; it is always present in the first
SystemInformation message listed in the schedulingInfoList list.
systemInfoValueTagList
Indicates SI message specific value tags. It includes the same number of
entries, and listed in the same order, as in SchedulingInfoList.
systemInfoValueTagSI
SI message specific value tag as specified in Clause 5.2.1.3. Common for
all SIBs within the SI message other than SIB14.
trackingAreaCode
A trackingAreaCode that is common for all the PLMNs listed.

TABLE 35

| Conditional | |
|---|---|
| presence | Explanation |
| inband | The field is mandatory present if IE operationModeInfo in |
| | MIB-NB is set to inband-SamePCI or inband-DifferentPCI. |
| | Otherwise the field is not present. |
| inband- | The field is mandatory present, if IE operationModeInfo in |
| SamePCI | MIB-NB is set to inband-SamePCI. Otherwise the field is |
| | not present. |

‘/’ described in the present disclosure can be interpreted as ‘and/or’, and ‘A and/or B’ may be interpreted as having the same meaning as ‘including at least one of A or (and/or) B’.

Hereinafter, in the standalone operation of the MTC proposed in the present disclosure, a method of utilizing a legacy LTE control region that was not used in the conventional LTE MTC will be described.

For convenience of explanation, LTE-MTC supporting only conventional LTE in-band operation will be referred to as ‘eMTC’, MTC supporting standalone operation will be referred to as ‘sMTC’, and legacy LTE will be referred to as ‘LTE’.

The sMTC cell is not obligated to support a control region for a conventional LTE UE. Therefore, the control region can be used for the following purposes for sMTC service.

That is, the LTE control region may be used for (1) performance improvement, (2) data rate improvement, and (3) control signaling purpose.

### First Embodiment: Method of Utilizing the LTE Control Region for Performance Improvement

The first embodiment is related to a method of improving channel estimation, synchronization and/or measurement performance by transmitting an RS in the LTE control region for improving sMTC performance, or a method of improving MPDCCH/PDSCH performance by additionally transmitting MPDCCH/PDSCH data in the LTE control region to lower the code rate.

(Method 1): The Method of Transmitting an RS

The method 1 is to transmit a cell-specific RS such as a CRS (in addition to the CRS understood by the LTE or eMTC terminal) in the LTE control region.

The additionally transmitted RS may be used to improve MPDCCH/PDSCH channel estimation performance, or may be used to improve measurement accuracy such as RSRP/RSRQ.

Alternatively, a UE-specific DMRS may be transmitted to the LTE control region.

The DMRS is basically configured to be transmitted in the time/frequency domain in which the corresponding MPDCCH/PDSCH is transmitted.

Therefore, in order to improve channel estimation and/or synchronization performance of MPDCCH/PDSCH used for a specific purpose by using the LTE control region, the base station may transmit the DMRS corresponding to the scheduled MPDCCH/PDSCH subframe (#n) in the LTE control region of the previous subframe(s) (e.g., subframe (n−1), (n−2), . . . ) of the subframe (#n).

Alternatively, for fast synchronization in the LTE control region, the base station may transmit a burst sync such as RSS (resynchronization signal) or transmit WUS (wake-up signal) in the LTE control region.

The terminal checks both the WUS and the MPDCCH in the subframe. If the WUS is detected and the MPDCCH is not yet detected, the UE continues to monitor the MPDCCH. If the WUS is not detected until the max duration, the UE may stop the MPDCCH monitoring.

(Method 2): The Method of Lowering the Code Rate of MPDCCH/PDSCH Data

The method 2 relates to a method of using an LTE control region to transmit MPDCCH/PDSCH data RE (from a data point of view).

The data RE is mapped by rate matching the data RE to a portion other than the portion of the RS (including all RSs that can be understood by the LTE or eMTC terminal as well as the above-described additional RS), or in a form in which data RE is punctured by the RS.

Alternatively, to be used for the original purpose, frequency tracking, and/or coherent combining between OFDM symbols, the terminal may preferentially select some (here, including a minimum of REs that may be overlapped at the position of the CRS (that can be understood by the LTE or eMTC terminal) of the control region or the additional RS described above) of the MPDCCH/PDSCH OFDM symbols (included in the same slot of subframe, or adjacent subframe), or may preferentially select a symbol not including RS.

In addition, the terminal may use in a form of copying some symbols (some symbols may vary) selected according to the number of symbols included in the LTE control region to the LTE control region.

Here, in order not to affect the eMTC operation, when the base station transmits the CRS in the LTE control region even though it is not LTE inband, the base station may copy data to the LTE control region and then puncturing by CRS.

Here, in order to obtain a similar combining (SNR) gain for all data REs in the copied OFDM symbol, that is in order to avoid the case that some data REs do not obtain a combining (SNR) gain due to CRS puncturing, OFDM symbols with CRS at the same location as the CRS location of the LTE control region are can be copied preferentially.

For convenience, the above method will be referred to as “the method of preferentially copying the CRS transmission symbol”. The method may be a method of preferentially copying the CRS transmission symbol(s) having the same CRS RE position as the CRS RE position transmitted to the LTE control region.

This method has the advantage of minimizing puncturing of the MPDCCH transmission RE by the CRS in the LTE control region.

In the method, in the case of normal CP (cyclic prefix), when the symbol index in the subframe is I (∈{0, 1, 2, . . . , 13}) and the number of symbols in the LTE control region is L, it can be copied as follow depending on the number of control regions.

(1) For normal CP: I∈{O, 1, 2, . . . , 13}

if L=1, I={7}->I={0} (A->B represents A copying to B)

if L=2, I={7, 8}->I={0, 1}

if L=3, I={7, 8, 9} or {7, 8, 6}->I={0, 1, 2}

When L=3, both of the above methods are possible, but I={7, 8, 6}->I={0, 1, 2} may be relatively advantageous in terms of latency.

if L=4, I={7, 8, 9, 10} or {7, 8, 9, 6} or {7, 8, 5, 6}->I={0, 1, 2, 3}

When L=4, all three methods above are possible, but I={7, 8, 5, 6}->I={0, 1, 2, 3} may be the most advantageous in terms of latency.

(2) For extended CP: I∈{0, 1, 2, . . . , 11}

if L=1, I={6}->I={0}

if L=2, I={6, 7}->I={0,1}

if L=3, I={6, 7, 8} or {5, 6, 7}->I={0, 1, 2}

When L=3, both of the above methods are possible, but I={5, 6, 7}->I={0, 1, 2} may be relatively advantageous in terms of latency.

For MBSFN(Multimedia Broadcast multicast service Single Frequency Network) subframe, the terminal cannot expect the CRS in the MBSFN region. By applying a technique similar to the above, the base station can transmit by preferentially copying the OFDM symbol(s) in which the MBSFN RS or DMRS overlapping the CRS exists to the LTE control region in the order of time or in the order in which there are many MBSFN RSs or DMRSs overlapping the CRS.

In the former case (in the order of time), for example, if two ODFM symbols with I={2}, I={10} meet the above conditions, it is copied in the form of I={2,10}->I={0,1}. If L=1 in this situation, it is copied in the form of I={2}->I={0} or I={10}->I={0}. Both methods are possible, but the former has an advantage in terms of latency compared to the latter.

The above methods are not limited only to the same subframe or slot, but are applied equally to adjacent subframes or slots. That is, the MPDCCH/PDSCH of subframe #N or some of them may be copied (or RE mapping) to the LTE control region of subframe #N+1 or #N−1.

In addition, when the MPDCCH/PDSCH is not transmitted in the corresponding subframe (subframe #N), such as in the case of TDD special subframe configuration 0/5 or MBSFN subframe, the method may be applied in such way that the MPDCCH/PDSCH of the adjacent previous MPDCCH/PDSCH transmission DL subframe (subframe #N−1) or some of them is/are copied (or RE mapping) to the LTE control region of TDD special subframe configuration 0/5 (subframe #N) in which the MPDCCH/PDSCH is not transmitted.

Alternatively, for the LTE control region of the MBSFN subframe in which the MPDCCH/PDSCH is not transmitted, similar to the above method, the base station may transmit by copying (or RE mapping) the MPDCCH/PDSCH of an adjacent MPDCCH/PDSCH transmission DL subframe or some of them

Separately or additionally from methods considering the use of frequency tracking and/or coherent combining between OFDM symbols, to minimize latency, or for services such as URLLC where latency is important, OFDM symbols closest to the LTE control region may be copied.

In addition, a method of preferentially copying the RS transmission symbol may be considered. In the RS preferential transmission method, by copying the RS instead of random data, more samples (i.e., RE) can be used for frequency tracking for frequency tracking, or gains such as improved channel estimation accuracy using an additional RS can be obtained. The RS may be, for example, CRS. In this case, the gain described in the method of preferentially copying the CRS transmission symbol can be additionally expected.

The RS may also be, for example, DMRS. This method will be referred to as the method of preferentially copying the DMRS transmission symbol. The method of preferentially copying the channel estimation DMRS transmission symbol may consider a method of preferentially copying the RS transmission symbol. In the RS preferential transmission method, by copying the RS instead of random data, more samples (i.e., RE) can be used for frequency tracking for frequency tracking, or gains such as improved channel estimation accuracy using an additional RS can be obtained.

The RS may be, for example, CRS. In this case, the gain described in the method of preferentially copying the CRS transmission symbol can be additionally expected. The RS may also be, for example, DMRS. This method will be referred to as the method of preferentially copying the DMRS transmission symbol. The method of preferentially copying the DMRS transmission symbol has the advantage of additionally obtaining channel estimation by using the DMRS signal copied to the LTE control region.

In addition, when the DMRS is power boosted, due to an increase in the SNR of the DMRS RE, a gain in terms of sync. can be additionally expected.

In the case of RE mapping by copying a part of the MPDCCH to the LTE control region, the part of the copied and RE mapped MPDCCH may be defined by one or more OFDM symbol(s) on the time axis, and by one or more PRB(s) on the frequency axis.

In this case, the OFDM symbol(s) defined as the time axis may be defined by a combination of OFDM symbol indexes. For example, in the case of the method of preferentially copying the CRS transmission symbol, the OFDM symbol index(s) defined as time axis may be OFDM symbol index(s) of the MPDCCH OFDM symbols containing CRS transmission REs of the same subcarrier indexes as those of CRS transmission REs in the LTE control region.

Alternatively, the OFDM symbol index(s) defined as time axis may be OFDM symbol index(s) of the OFDM symbols containing DMRS transmission REs.

The MPDCCH REs mapped to the LTE control region may be limited to one or a plurality of PRB(s) regions defined or limited in the frequency axis, and may be REs that satisfy the following conditions at the same time.

REs used for MPDCCH transmission

REs including reference signals (RSs) (e.g., CRS, DMRS) in PRBs used for MPDCCH transmission

REs that do not collide with CRS REs in the LTE control region after mapping to the LTE control region

That is, REs that do not have the same subcarrier indexes as the indexes of CRS REs in the LTE control region.

REs puncturing MPDCCH transmission REs (e.g., PSS, SSS, PBCH, CSI-RS)

The REs defined to puncturing MPDCCH transmission REs as described above may be included in the MPDCCH REs mapped to the LTE control region.

In this case, since the REs defined for puncturing MPDCCH transmission REs are known signals, the corresponding signals can be used for sync. or channel estimation.

The REs defined to puncturing MPDCCH transmission REs as described above can be excluded from the MPDCCH REs mapped to the LTE control region. In this case, instead of the REs puncturing the MPDCCH transmission RE, the punctured MPDCCH transmission REs are copied to the LTE control region and are then mapped to REs.

In this case, the number of the same REs between the LTE control region and the MPDCCH in the same subframe decreases, and thus there may be drawback in terms of sync. However, at the time of MPDCCH repetition (no REs defined to puncturing the MPDCCH transmission REs), performance improvement can be expected through averaging or combing gain by using the same point between the neighboring subframe and the LTE control region.

To get the advantage in terms of frequency tracking from the method of copying some OFDM symbol(s) of MPDCCH or PDSCH symbol(s) to LTE control region for the purpose of frequency tracking, or for the method of copying some OFDM symbol(s) of the MPDCCH or PDSCH symbol(s) to an LTE control region, the corresponding MPDCCH or PDSCH transmission should be expected by the terminal. That is, the terminal should be able to deterministicly know the transmission time point of the corresponding MPDCCH or PDSCH to obtain a frequency tracking gain by repetition of OFDM symbol(s). If not, that is, when the terminal cannot know the transmission time point of the MPDCCH or PDSCH, or when blind detection and/or decoding is required to confirm MPDCCH or PDSCH transmission with only information on the transmission time point, (in the case that the actual transmission is not made or the above method is not applied) the terminal cannot receive due to an incorrect estimated value.

For the same reason as above, the method of copying some OFDM symbol(s) of the MPDCCH or PDSCH symbol(s) to the LTE control region for frequency tracking may be applied only when the UE is able to deterministicly determine the transmission time point (deterministic transmission or deterministic scheduling), such as MPDCCH and/or PDSCH for broadcast transmission.

Alternatively, in order to obtain an advantage in terms of frequency tracking from the method of copying some OFDM symbol(s) of the MPDCCH or PDSCH symbol(s) to the LTE control region, the method may be applied only when the UE is able to deterministicly determine the transmission time point (deterministic transmission or deterministic scheduling), such as MPDCCH and/or PDSCH for broadcast transmission.

The case of that the UE is able to deterministicly determine the transmission time point (deterministic transmission or deterministic scheduling) may include, for example, a channel that is periodically transmitted (repeatedly) at a time point that the UE can know, such as a PBCH or an MPDCCH and/or a PDSCH for transmitting SIB and/or SI messages.

For the above reasons, the method of copying some OFDM symbol(s) of the MPDCCH or PDSCH symbol(s) to the LTE control region, is applied only when the UE is able to deterministicly determine the transmission time point (deterministic transmission or deterministic scheduling).

And, in other cases, that is, in the case of transmission in which the UE cannot deterministicly determine the transmission time point, the following method of MPDCCH or PDSCH rate matching may be applied, or a method of copying some OFDM symbol(s) of the MPDCCH or PDSCH symbol(s) designed for a purpose other than the frequency tracking purpose to the LTE control region (e.g., a method for preferentially copying OFDM symbols with CRS at the same location as CRS location of LTE control region to LTE control region) may be applied.

The method of MPDCCH or PDSCH rate matching may be a method of sequentially frequency first RE mapping coded bits from the LTE control region (R1) (R1→R2 RE mapping method), or a method of sequentially frequency first RE mapping remaining coded bits (may be additional parity bits) to the LTE control region (R2→R1 RE mapping method) after performing frequency first RE mapping sequentially coded bits on the MPDCCH or PDSCH transmission region for backward compatibility with legacy or for data sharing.

The part copied or mapped to the LTE control region may be part of coded bits or modulation symbols of MPDCCH/PDSCH or PDCCH/PDSCH transmission REs.

Additionally, when the MPDCCH/PDSCH is repetitioned, in order to maximize coherent combining between subframes, the same repetition may be performed up to the LTE control region, or the repeated OFDM symbol may be changed for each repetition or for a predetermined repetition so that the OFDM symbols copied from the MPDCCH/PDSCH to the LTE control region are as uniform as possible considering the total number of repetitions. The set of OFDM symbol(s) copied to the LTE control region and repeated may be determined in conjunction with the MPDCCH/PDSCH repetition number and/or repetition index (i_rep).

For example, it is assumed that the LTE control region is composed of the first 3 OFDM symbols (i=0,1,2) of the subframe, and the MPDCCH/PDSCH OFDM symbols are followed by 11 OFDM symbols (i=3,4,5,6,7,8,9,10,11,12,13).

The OFDM symbol index in the MPDCCH/PDSCH copied to the LTE control region according to the MPDCCH/PDSCH repetition number may be determined as follows.

(Example 1) Repetition number=4 (i_rep=0,1,2,3)

i_rep=0: {3,4,5}; i_rep=1: {6,7,8}; i_rep=2: {9,10,11}, i_rep=3: {12,13,3}

(Example 2) Repetition number=8 (i_rep=0,1,2,3,4,5,6,7)

i_rep=0: {3,4,5}; i_rep=1: {3,4,5}; i_rep=2: {6,7,8}; i_rep=3: {6,7,8}

i_rep=4: {9,10,11}, i_rep=5: {9,10,11}, i_rep=6: {12,13,3}; i_rep=7: {12,13,3}

In Example 1, the set of OFDM symbol(s) copied to the LTE control region and repeated is configured to include the MPDCCH/PDSCH OFDM symbols as uniform as possible within the repetition number. When the repetition number is sufficient as in Example 2, a set of OFDM symbol(s) may be configured to enable (OFDM) symbol level combining between adjacent subframe(s). The above example may have different values depending on the number of symbols included in the control region and the number of repeated transmissions. In addition, the above example can be similarly applied as a value for avoiding redundant symbols between repeated transmissions as much as possible.

The methods of using the LTE control region during the repetition may be differently applied according to 1) repetition number and/or CE mode (method A), 2) frequency hopping (method B), 3) RV cycling (method C).

(Method A): A Method of LTE Control Region RE Mapping According to the Repetition Number and/or CE Mode

As mentioned above, the above methods may have different effects according to the repetition number, and thus may be determined in conjunction with the repetition number. Alternatively, since the range of the supported repetition number is different according to the CE mode, the above methods may be applied differently according to the CE mode. For example, since CE mode B mainly aims to extend coverage through repetition gain, Example 2 may be applied only to terminals operating in CE mode B, and Example 1 may be used for terminals operating in coverage mode A. When applying Example 2 to terminals operating in CE mode B, the duration X in which the set of OFDM symbol(s) copied to the LTE control region by enabling (OFDM) symbol level combining maintains the same may be determined in consideration of the channel coherence time, etc. The X may be a subframe unit or a slot unit.

(Method B): A Method of LTE Control Region RE Mapping According to Frequency/Narrowband Hopping

The duration X in which the set of OFDM symbol(s) copied to the LTE control region by enabling (OFDM) symbol level combining maintains the same is meaningful only in the same (frequency/narrowband) hop. Therefore, the methods may be determined according to whether frequency/narrowband hopping is configured. For example, when frequency hopping is ‘on’, it is determined that the gain by symbol level combining is small, and as in Example 1, a method of copying different parts without repetition may be applied, or the size of the duration of X can be determined according to a length of (frequency/narrowband) a hop. Here, the range of the duration X value may range from 1 to the number of subframes or slots in the hop, and X=1 may mean a case where different parts are copied without repetition as in Example 1.

(Method C): A Method of LTE Control Region RE Mapping According to RV Cycling

The duration X in which the set of OFDM symbol(s) copied to the LTE control region by enabling (OFDM) symbol level combining maintains the same may be a value limited by a period of the RV cycling when the RV cycling is applied. In addition, the method of LTE control region RE mapping according to the RV cycling may be a method determined in conjunction with the CE mode. For example, when a terminal operating in CE mode A is configured to perform the RV cycling at every repetition, since repetition gain cannot be obtained, the above Example 1 may be applied to operate. A terminal operating in CE mode B may be configured to have the same RV for a certain duration Z. The duration X value may be configured to have a value equal to or smaller than the Z value or calculated in the terminal, or the X value may be referred to as the Z value as it is.

At the time of the repetition, the methods of using the LTE control region (e.g., whether to copy or map a different part for each repetition or a specific repetition unit, or whether to copy or map the same part for all repetitions) may be UE-specifically or semi-statically configured through a cell-specific RRC signaling.

For example, in the case of a method of copying or mapping OFDM symbol(s) including CRS, when the CRS transmission port is 2 or more, the positions of the CRS transmission REs of OFDM symbol index 0 and 3 are the same.

In order to allow copying of different parts (e.g., different CRS transmission symbols) only in this case, the copying of different parts may be allowed depending on the number of CRS transmission ports (that is, only in the case of 2 or more), or may be configured to be configurable through higher layer signaling as described above.

When RE mapping the LTE-MTC MPDCCH/PDSCH to the LTE control region in frame structure type 2 (TDD), even if the LTE control region includes PSS to protect the PSS located at symbol index I=2 of the TDD special subframe, that is even if the MPDCCH/PDSCH start symbol I_startsymbol>2, the copying or RE mapping the MPDCCH/PDSCH to the position of the PSS (that is, the symbol index I=2) may not be performed.

(Example) special subframe capable of MPDCCH/PDSCH transmission (e.g., special subframe configuration #4)

When I_startsymbol=3 and normal CP, when copying or RE mapping OFDM symbols corresponding to OFDM symbol indexes 7, 8, and 9 to OFDM symbol indexes 0, 1 and 2, respectively, they collide with the PSS. In this case, by applying the above method, it is possible to copy or RE-map OFDM symbols corresponding to OFDM symbol indexes 7 and 8 to OFDM symbol indexes 0 and 1, respectively, excluding OFDM symbol index 9. In the case of the PDSCH, it may be excluded from rate-matching.

When I_startsymbol=3 and extended CP, when copying or RE mapping OFDM symbols corresponding to OFDM symbol indexes 6, 7, and 8 to OFDM symbol indexes 0, 1 and 2, respectively, they collide with the PSS. In this case, by applying the above method, it is possible to copy or RE-map OFDM symbols corresponding to OFDM symbol indexes 6 and 7 to OFDM symbol indexes 0 and 1, respectively, excluding OFDM symbol index 8. In the case of the PDSCH, it may be excluded from rate-matching.

More generally, when the TB scheduling unit is not a subframe or slot, for example, when the minimum unit of scheduling is N subframes or slots in time by applying an uplink sub-PRB, the operation may be performed in units of N subframes or slots, not in units of a subframe or slot. The operation includes operating in units of M*K subframes or slots, since 1 TB is transmitted over M*K subframes or slots when 1 TB is divided into multiple M RUs and transmitted, and the length of one RU in time is K subframes or slots.

Method of PBCH Extension

In order to improve the performance of the PBCH, the base station and/or the terminal may extend or copy all or some of the OFDM symbol(s) of the PBCH (consisting of 4 OFDM symbols) in the LTE control region and transmit. When copying some OFDM symbol(s) of the PBCH, a pattern may be configured for the purpose of correcting a performance difference due to differences in PBCH patterns between TDD/FDD, for example.

In the case of FDD, all four OFDM symbols constituting the PBCH included in the four PBCH repetitions are equal to four. In the case of TDD, two of the four OFDM symbols constituting the PBCH are repeated 5 times, and the other two OFDM symbols are repeated 3 times. In the case where it is not necessary to assume the CRS in the LTE control region in the sMTC, a more flexible configuration may be possible.

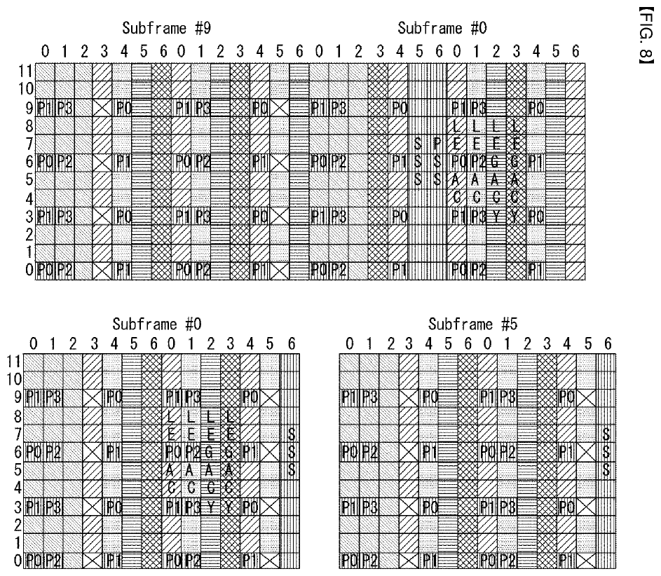

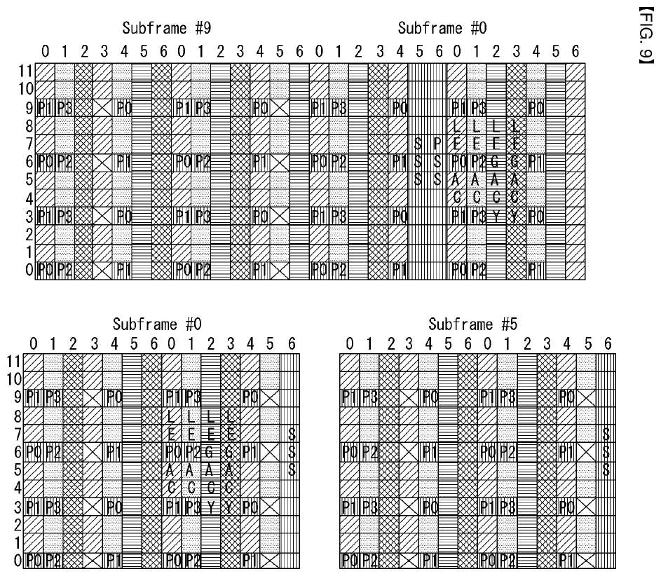

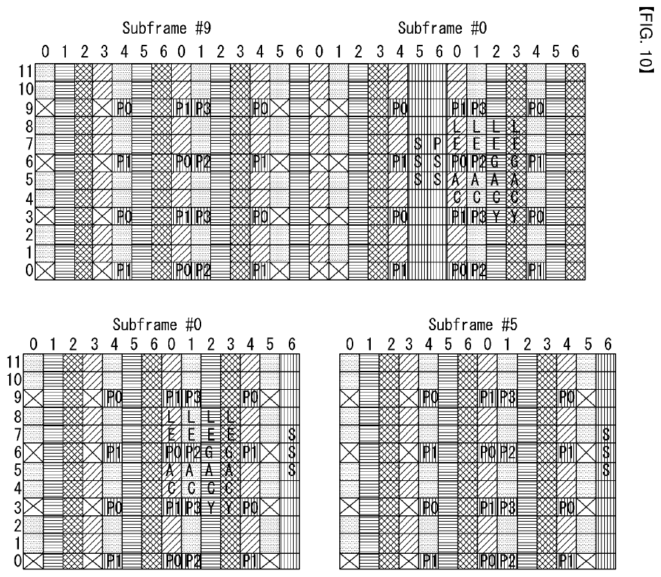

FIG. 8 is a diagram illustrating that 4 PBCH repetitions are applied in the conventional eMTC, and FIGS. 9 to 11 illustrate methods of extending a PBCH to the LTE control region for an sMTC UE proposed in the present disclosure. FIG. 9 (Example 1) and FIG. 10 (Example 2) are examples of a case where a CRS is transmitted in the LTE control region, and FIG. 11 (Example 3) is an example of a case where a CRS is not expected in the LTE control region.

In addition, the method of extending the PBCH to the LTE control region may be used to reinforce a point where frequency estimation performance compared to FDD may be relatively weak when PBCH is used in TDD in the eMTC. The eMTC FDD was able to improve the frequency tracking performance by using repetition between OFDM symbols while placing PBCH repetition in subframes #0 and #9. However, eMTC TDD had to place PBCH repetition in subframes #0 and #5 to support PBCH repetition in all TDD U/D configurations. Thus, eMTC TDD could not obtain a gain in terms of frequency tracking performance as much as FDD. In Examples 2 and 3, the PBCH configuration symbols extended to the control region in TDD are arranged to be most advantageous in terms of frequency tracking performance by forming equal intervals with the same PBCH OFDM symbols repeated later. The above examples are an arrangement that satisfies two uses: a use for correcting a performance difference due to differences in PBCH patterns between TDD/FDD and a use for reinforcing frequency estimation performance in TDD.

As another method, in order to reduce the PBCH detection delay time of the terminal, the base station may transmit part of the encoded bits to be included in the next PBCH transmission subframe or part of the PBCH OFDM symbols. That is, some information of the (n+1) to (n+3)-th PBCH transmission subframe may be transmitted in the control region of the n-th PBCH transmission subframe. This may be for the terminal to attempt to detect at the lowest possible PBCH code rate in one subframe.

Alternatively, some of the encoded bits to be included in the PBCH transmission subframe or some of the PBCH OFDM symbols may be transmitted in the LTE control region of the subframe(s) following the PBCH transmission subframe.

### Second Embodiment: Method of Utilizing the LTE Control Region to Improve a Data Transmission Rate

In order to improve the data transmission rate, the LTE control region may be used for MPDCCH/PDSCH data transmission. In the following, for convenience of description, the LTE control region is referred to as R1 and the MPDCCH/PDSCH region is referred to as R2.

As the method for improving the data transmission rate, a method of encoding (channel coding) data transmitted in R1 and data transmitted in R2 in a single part and a method of encoding in two parts may be considered.

In addition, the methods proposed below are not limited to use for improving data transmission speed, and may also be used as methods for improving performance. For example, when additional parity information for error correction is transmitted in R2, methods proposed below may be classified as the method of utilizing the LTE control region for improving performance.

(Method 1): Single Part Encoding for sMTC Data Rate Enhancement

The single part encoding method is a method of constructing a channel coding input as a single part based on the RE of a region including R1 and R2 for sMTC data rate enhancement, and generating a coded bit by rate matching in the channel coding step. Rate-matched coded bits are RE mapped to R1 and R2 through modulation (e.g., QPSK, 16 QAM, etc.).

RE mapping of the single part encoding method may perform frequency-first time-second RE mapping in the order of R1→R2 without considering data sharing with eMTC. The above method has an advantage that a buffer required for reordering at the RE mapping input end is unnecessary or a required buffer size is small by performing RE mapping in the input order.

Alternatively, systematic bits among coded bits may be preferentially mapped to R2 in consideration of data sharing with eMTC, and then the remaining coded bits may be RE-mapped to R1. Through the RE mapping method, decoding can be performed independently with only R2, but if both R1 and R2 are used, the code rate is lowered and reception is possible at a relatively low SNR.

In addition, sMTC and eMTC receive essential data through R2, and sMTC may also receive essential data even in a lower SNR area by receiving additional information by additionally receiving some kind of auxiliary data through R1, or by receiving additional redundancy data through R1.

With the single part encoding method, corresponding information (e.g., whether both R1 and R2 are received, RE mapping method, etc.) is signaled through a higher layer configuration or scheduling DCI in order for sMTC UE to enable receive data of R2, or R1 and R2.

(Method 2): 2-Part Encoding for sMTC Data Rate Enhancement

The two part encoding method is a method of independently encoding data to be transmitted through R2 and data to be transmitted through R1. If the part that is RE-mapped to R1 is called part 1, the part that is RE-mapped to R2 is called part 2, and each code rate is C1 and C2, then rate matching in part 1 is performed based on the number of (available) REs in C1 and R1, and rate matching in part 2 is performed based on the number of (available) REs of C2 and R2. Since C1 and C2 may be data of different characteristics, they can be independently configured.

For example, eMTC and sMTC may commonly receive common data having the code rate C2 through R2, and sMTC may independently receive sMTC-specific data having the code rate C1.

In this case, the independent data of R1 may not be indicated with HARQ process ID or may not support HARQ-ACK feedback. In addition, resource allocation information of R1 (e.g., MCS, TBS, etc.) may be indirectly derived from scheduling information of the R2 part. If the R2 part also supports HARQ retransmission, it may be dependent on the R2 part. This may be HARQ-ACK feedback by setting the HARQ ID to the same value or by combining detection results of R1 and R2 parts. Alternatively, one HARQ ID and an additional 1 bit indication may be used to distinguish whether the R2 part or the R1 part in the corresponding subframe or slot. This information may be transmitted in DCI. In addition, when frequency retuning is required, the R1 duration may be allowed to be used as a guard time.

Payload bits transmitted through R2 and payload bits transmitted through R1 may be encoded by different channel coding methods due to a difference in payload size (or code block size resulting therefrom) between the two. For example, payload bits transmitted in R2 are encoded by the LDPC or the turbo coding method optimized for large payload size or code block size, and payload bits transmitted in R1 are encoded by the Reed Muller code or the polar coding method more suitable for small payload size or code block size.

Whether or not two part encoded data (including same or different channel coding) can be received may be defined in the form of UE capability and reported. The two part encoding method for sMTC data rate enhancement can be applied only to capable UEs according to the reported UE capability. The capable UE may simultaneously perform decoding using two decoders to reduce latency in case of the two part ending.

The data transmitted in R1 may be information common to sMTC UEs, or information such as broadcast information, SC-PTM information, paging, and Msg2/4 during random access. The sMTC UE may simultaneously receive data transmitted through R1 along with MPDCCH/PDSCH data transmitted through R2 (depending on UE capability).

When the LTE control region is used for MPDCCH/PDSCH data transmission (or when the LTE control region is extended to rate-matching), if the max code rate of MPDCCH/PDSCH data is maintained, due to the increase in the number of transmitted REs, higher TBS allocation is theoretically possible. In this regard, when a TBS is newly defined or an additional TBS size is defined and supported, the UE configured to expect MPDCCH/PDSCH transmission in the LTE control region may calculate the TBS differently.

When an area in which DL or UL transmission is possible increases or decreases in an LTE subframe, a TBS value calculated through the number of MCS and PRB may be used by scaling.

For example, if the area in which DL or UL transmission is possible increases or decreases, the scaling factor X is determined according to the increased or decreased ratio, and a value subjected to the integerization process by multiplying the corresponding scaling factor X by TBS which is obtained through TBS table lookup using the number of MCS and PRB is used as the TBS value. Alternatively, the closest value on the TBS table may be applied as a new TBS when the integerization process is performed.

The integerization process may be an operation such as round/floor/ceiling. When the closest value on the TBS table is greater than 1, a larger TBS value can be selected, or a smaller value can be selected. If the TBS value after multiplying the scaling factor X is TBS′, when the TBS′ value is larger than the TBS size (e.g., 1000 bits) allowed by LTE MTC, 1000 bits is selected.

That is, TBS′ may be selected as min (1000, TBS′). The above method may be effective when the number of OFDM symbols capable of PDSCH transmission is small (e.g., special subframes), for example. In this case, since the number of OFDM symbols capable of transmitting PDSCH in a special subframe is smaller than that of a normal subframe, if the TBS scaling parameter is Y, it may be in the form of additionally multiplying Y by X.

Alternatively, a terminal configured to expect MPDCCH/PDSCH transmission in the LTE control region may calculate a repetition differently or may be configured a repetition value different from that of the eMTC. For example, when using the LTE control region to improve performance (e.g., when using the LTE control region by the above methods of transmitting RS and/or lowering the code rate of MPDCCH/PDSCH data, etc.), as performance is improved, a small number of repetitions can be applied.

In the method of applying a new repetition, a terminal configured to set a new value different from the existing eMTC or to expect MPDCCH/PDSCH transmission in the LTE control region can calculate a repetition value to be actually applied from the value set identically to the eMTC. The calculation method may be, for example, a value integerized through an operation such as floor/round/ceil by multiplying a specific value (e.g., a scaling factor that is inversely proportional to the degree of performance improvement) from the value configured identically to the eMTC. In addition, in order to enable the sMTC UE to receive the data of R2 or R1 and R2 by the two part encoding method described above, corresponding information (e.g., whether both R1 and R2 are received, RE mapping method, encoding information, etc.) is signaled through a higher layer configuration or scheduling DCI.

In addition, in order to allow the sMTC UE to receive one data unit only through R2 or through R1 and R2 (or through R1 only) as in the single part encoding method described above, corresponding information (e.g., whether data is transmitted using R1 or R2 or both R1 and R2 ) is signaled through a higher layer configuration or scheduling DCI.

When the LTE control region is used for PDSCH data transmission (using single-part encoding or two-part encoding) (or when the LTE control region is extended by rate-matching), and when data sharing between the sMTC UE and the (legacy) eMTC UE is supported, the redundancy version (RV) value according to the repetition of the sMTC UE and the starting position in the circular buffer corresponding to the RV may always have the same value as the eMTC UE.

This method does not configure one or a plurality of circular buffers based on all of the coded bits transmitted in R1 and R2 for the sMTC UE, and does not determine the starting position in the circular buffer with a certain ratio of the size of each configured circular buffer, but configures one or more circular buffers based on the coded bits transmitted to R2. In addition, a starting position in the circular buffer may be determined at a predetermined ratio of the size of each configured circular buffer.

When the LTE control region is used for PDSCH data transmission (using single-part encoding or two-part encoding) (or when the LTE control region is extended by rate-matching), and when data sharing between the sMTC UE and the (legacy) eMTC UE is not supported, the redundancy version (RV) value according to the repetition of the sMTC UE and the starting position in the circular buffer corresponding to the RV may have a different value from the eMTC UE. For example, this method may configure one or more circular buffers based on all of the coded bits transmitted in R1 and R2 for the sMTC UE, and determine the starting position in the circular buffer at a certain ratio of the size of each configured circular buffer.

The above method may mean operating a circular buffer independently for R1 and R2 when the LTE control region is used for PDSCH data transmission. Here, if each circular buffer corresponding to R1 and R2 is referred to as CB1 and CB2, CB2 has the same size as the circular buffer of eMTC.

If the circular buffer of eMTC is composed of an N_row×N_column matrix, for example, N_column=32, and N_row is determined by N_column and channel coding output bit stream size, sMTC CB2 has the same N_row×N_column size as eMTC and dummy bit (if necessary) is also filled in the same way as eMTC. The circular buffer corresponding to PDSCH data added by using the LTE control region has the same N_column value as CB2, and the N_row value is determined according to the amount of added data. When the circular buffer is composed of an N_row×N_column matrix, the read-out start column value of the circular buffer matrix is determined according to the RV value (e.g., read-out start column values are 2, 26, 50, 74 corresponding to RV0, RV1, RV2, RV3, respectively). The read-out start column value in the circular buffer according to the RV value of CB1 may have the same value as CB2.

When independent retransmission of PDSCH data is supported for R1 and R2, HARQ-ID and/or RV values for R1 and R2 data may be independently operated within the same subframe or slot. Here, in order to reduce the DCI signaling overhead, the initial transmission of R1 data is applied (the HARQ-ID and) the RV value of R2 of the same subframe, but when retransmission, the same RV value as the initial transmission or a specific value (e.g., RV0) can be assumed.

Regarding two methods of the redundancy version (RV) value according to the repetition of the sMTC UE and the starting position in the circular buffer corresponding to the RV, depending on whether it is an sMTC UE or an eMTC UE (e.g., depending on whether the LTE control region is used), or whether the sMTC UE supports data sharing between the sMTC UE and the eMTC UE (or with reference to the corresponding signaling), the redundancy version (RV) value according to repetition and the starting position in the circular buffer corresponding to the RV may be determined.

The definition of EREG and ECCE of MPDCCH in eMTC is defined for symbol index I=0˜13 (in case of normal CP) in subframe. However, the actual MPDCCH transmission is performed using only REs belonging to the OFDM symbol (that is, satisfy the condition of I≥startSymbolBR) including the starting symbol (startSymbolBR). When a sMTC UE is configured to use the LTE control region, MPDCCH transmission is also possible for OFDM symbol(s) before I=startSymbolBR. In this case, the following methods may be considered as the MPDCCH RE mapping method of the sMTC UE.

First, the MPDCCH may be transmitted in a frequency-first-time-second manner from I=0 or the first OFDM symbol in which the configured sMTC UE can transmit the MPDCCH.

This method may mean that when determining the MPDCCH transmission RE of eMTC, startSymbolBR is replaced with ‘0’ or the value of the first OFDM symbol in which the configured sMTC UE can transmit the MPDCCH under the condition of 1 startSymbolBR. The above method has the advantage of simple RE mapping from the standpoint of supporting only the sMTC UE, but the RE mapping order are different from that of the eMTC UE, so MPDCCH data sharing with the eMTC UE is not efficiently supported.

Second, after RE mapping starting from I=startSymbolBR in the same way as eMTC, for REs added by using the LTE control region, RE mapping may be performed in a frequency-first-time-second manner from I=0 or the first OFDM symbol in which the configured sMTC UE can transmit the MPDCCH. The above method has the advantage of efficiently sharing MPDCCH data because the understanding of the RE mapping position and order of sMTC and eMTC is the same for OFDM symbols satisfying I≥startSymbolBR.

This method may be useful when transmitting a control signal applied to both the existing eMTC and sMTC (or applied regardless of the eMTC and sMTC). In this case, the MPDCCH transmission REs available only to the sMTC UE(s) may be used for redundancy transmission or additional control data transmission for only additional sMTC UE(s). Alternatively, some of OFDM symbols (or REs) belonging to OFDM symbols satisfying I≥startSymbolBR may be copied and transmitted.

The above methods may be determined according to the type of control data transmitted through the MPDCCH or the search space (SS) type. For example, when control data transmitted through MPDCCH is UE-specific or transmitted through UE-specific search space (UESS), it may not be necessary to consider data sharing with eMTC, so sMTC may apply the first method described above.

Alternatively, when control data transmitted through MPDCCH is common to sMTC UE(s) and eMTC UE(s), or transmitted through a common search space (CSS), the second method that has an advantage in terms of data sharing with eMTC may be determined to be used.

In the conventional eMTC, when MPDCCH is transmitted, if the code rate of control data is more than a certain value (e.g., code rate>˜0.8), considering that it is difficult to receive from the terminal side, If the number of MPDCCH transmission REs (nRE, eMTC) of eMTC is less than a specific value in the state assuming the size of a specific DCI format or considering the size of the overall DCI format, the MPDCCH format is selected to double the ECCE aggregation level (AL), that is, double the ECCE AL.

For example, if the code rate is less than nRE,eMTC=104 corresponding to about 0.8, ECCE AL is to be increased. However, in the case of the sMTC UE, the RE (nRE, sMTC) that can be used for MPDCCH transmission in the same subframe or slot is greater than or equal to the eMTC. That is, the relationship between nRE and sMTC>=nRE and eMTC is established. Here, the ECCE AL determination for the sMTC UE may be determined in the following manner.

First, the ECCE AL of sMTC is determined based on the number of MPDCCH transmission REs of eMTC (nRE, eMTC). For example, if nRE,eMTC<104, the ECCE AL of sMTC is increased. Since for the number of MPDCCH transmission REs, the relationship between nRE, sMTC>=nRE, eMTC is always established, in certain cases, for example, in the case of nRE, eMTC<104<=nRE, sMTC, it is not necessary to increase the ECCE AL from the viewpoint of the sMTC UE, but after both the sMTC UE and the eMTC UE determine the ECCE AL based on nRE, eMTC, by using REs as much as nRE, sMTC-nRE, eMTC to improve the performance of MPDCCH for sMTC UE(s) or to transmit additional control data in the determined ECCE AL, the above method is an advantageous method in terms of performance compared to the second method.

In this method, nRE and eMTC, which are the criteria for determining the ECCE AL, even if the MPDCCH for an actual eMTC UE is not a transmission RE, for example, even if it is an MPDCCH transmission RE for an sMTC UE, may mean the number of MPDCCH transmission REs that satisfy the I≥startSymbolBR condition, that is, excluding the LTE control region.

Second, the ECCE AL of sMTC is determined based on the number of MPDCCH transmission REs of sMTC (nRE, sMTC). For example, if nRE,sMTC<104, the ECCE AL of sMTC is increased. In the case of this method, under certain conditions, sMTC may have an ECCE AL different from eMTC. For example, if nRE,eMTC<104<=nRE, sMTC, in the case of eMTC, the ECCE AL is doubled according to the conditions of nRE, eMTC<104, and in the case of sMTC, since 104<=nRE, ECCE AL may not be doubled. In this case, considering that sMTC has lower performance than eMTC control data, the base station increases the ECCE AL for the sMTC UE by 2 when the above conditions occur, that is, nRE, eMTC<104<=nRE, sMTC.

For the two methods for determining the sMTC ECCE AL, one of the two methods may be configured through a higher layer signaling, or may be applied differently depending on whether (control) data are shared between sMTC and eMTC.

For example, when (control) data are shared between sMTC and eMTC, the first method among the above methods may be selected or when (control) data are not shared, the first method among the above methods may be selected. Whether the sMTC and eMTC (control) data sharing is configured by higher layer or may be dynamically indicated through DCI.

The sMTC UE may include the meaning of an LTE MTC UE capable of using the LTE control region. In this case, the first method may be a method of determining AL (based on R2 ) only with REs belonging to the R2 region defined above among the number of MPDCCH transmission REs, similar to legacy LTE MTC UEs using the LTE control region.

In the case of a UE using the LTE control region, the second method may be a method of determining AL (based on R1 +R2 ) including REs belonging to the R1 region as well as the R2 region. The LTE MTC UE that can use the LTE control region may support only the second method, which is an R1 +R2 based AL determination method, to obtain the effect of transmitting additional control data within the same max code rate limit, or may use the second method, which is an R1 +R2 based AL determination method, as a basic operation, and apply the first method, which is an R2 based AL determination method, under a specific condition.

A specific condition for applying the first method may be, for example, a case in which the MPDCCH search space is shared with a conventional LTE MTC UE that cannot use the LTE control region. That is, the first method can be applied to the MPDCCH transmitted through the Type1-/1A-/2-/2A-MPDCCH CSS. Because, in the case of Type0-MPDCCH CSS, it is configured to be UE-specific in the same way as UESS and shared a search space with the UESS, rrom the standpoint of an LTE MTC UE capable of using an LTE control region, it may not be necessary to consider sharing a search space with a conventional LTE MTC UE that cannot use an LTE control region.

Therefore, in this case, for an LTE MTC UE capable of using an LTE control region, the AL can be determined by applying the same UESS method, that is, the second method, which is the R1 +R2 based AL determination method.

The sMTC ECCE AL determination method, when retuning frequency (or NB), because the first subframe or slot of the destination frequency (or NB) can be used as a guard period (GP), different methods may be applied to different subframes or slots of the same frequency (or NB). When all or part of the LTE control region is used as a GP, DL reception of the UE cannot be expected during the GP. Accordingly, since it is expected that the base station will not perform DL scheduling during the corresponding period, in this case, the sMTC ECCE AL determination may operate differently from a method signaled by a higher layer signaling or dynamic signaling. For example, in the first subframe or slot of the destination frequency (or NB), it may be determined based on the MPDCCH transmission RE calculated from OFDM symbols excluding the GP duration (e.g., the first one or two OFDM symbols) regardless of the signaling method, or the sMTC ECCE AL determination method (the first method) based on nRE, eMTC may be used.

When the MPDCCH is repeatedly transmitted by applying frequency (NB) hopping to an LTE MTC UE capable of using the LTE control region, the base station may apply the same AL determination method to all subframes in the same NB, and the LTE MTC UE capable of using the LTE control region may not receive the MPDCCH during the guard period (GP).

In this case, the UE may apply the same AL determination method to the same NB and perform an average operation to obtain a repetition gain in the same NB, excluding only some durations in the MPDCCH not received during the GP. Alternatively, an average operation for obtaining repetition gain may be performed using only the R2 region.

Alternatively, in order to reduce the complexity of the terminal operation, when transmitting the MPDCCH through frequency (NB) hopping, the base station may transmit the MPDCCH by applying the first AL determination method (using only the R2 region). In this case, the UE capable of using the LTE control region may refer to the higher layer configured frequency (NB) hopping on/off flag, and when frequency (NB) hopping is on, perform the reception of the MPDCCH and a BD operation for the reception by assuming the first AL determination method. If the frequency (NB) hopping is on and the hopping interval (the number of consecutive subframes used for MPDCCH transmission in the same NB between frequency hopping) is 1 or less than a specific value such as 2, the R1 +R2 based AL determination and RE mapping can be performed excluding as many OFDM symbols required for frequency retuning of the terminal in the R1 duration.

### Third Embodiment: Method of Utilizing the LTE Control Region for Control Signal Transmission

The LTE control region may be used for transmission of control signals for the sMTC UE. The control signal for the sMTC UE may be a mode indication indicating whether the cell supports sMTC, and control region indication information for the sMTC UE, as listed below.

First, it is described for the mode indication for sMTC devices.

In the case of the PBCH, the mode indication may be mode indication information that can only be understood by sMTC. For example, the mode indication may be an indication indicating whether sMTC is supported in a cell, or may indicated, when operating in-band or standalone, whether the corresponding frequency band (including eMTC or sMTC) is an LTE band, an NR band, a GSM band or a real standalone situation that does not belong to any band. For example, indication information on whether the corresponding cell supports sMTC is helpful in terms of sMTC device power saving. In addition, information on the RAT of the corresponding or neighboring band may be used for measurement, in-band operation, and the like. Alternatively, when the indication indicates that the cell supports only sMTC, there is an advantage of reconfiguring or optimizing the MIB field in the PBCH. For example, a specific field removed by removing unnecessary information such as phich-config from the aspect of the current eMTC from the MIB field may be used for another purpose, or reception performance may be improved by removing unnecessary fields. The following methods may be considered as the signaling method of the mode indication.

First Method: Method of Using Known Sequence

The first method may be a method of signaling by sequence detection (or selection), that is, a method of signaling through hypothesis testing.

For example, after designating 4 sequences in advance, it may be a method in which 2 bits are transmitted through 4 hypothesis testing.

Alternatively, it may be a method of signaling through a sequence initialization value. For example, signaling information to be transmitted using a gold sequence is used for gold sequence initialization, and the terminal may receive the signaling information used for initialization by performing sequence detection for a corresponding gold sequence.

Second Method: Repeat Legacy Sync Signals (PSS/SSS) with Some Potential Modifications

LTE PSS and/or SSS are used as they are, but a form different from the existing LTE FDD/TDD pattern may be used. Alternatively, by copying the PSS and/or SSS in a time or frequency reversed form to remove the possibility that a legacy eMTC device may be falsely detected, sMTC may receive a corresponding control signal by detecting a pattern between time reversed PSS/SSS.

Third Method: Repeat PBCH Signals with Some Potential Modifications

The third method can indicate a standalone mode, etc. by repeating the PBCH in a specific pattern. The PBCH repetition unit may be the entire PBCH (consisting of 4 OFDM symbols), or a part of the PBCH (i.e., some of the 4 OFDM symbols constituting the PBCH). For example, when configuring a pattern by copying a part of the PBCH to the LTE control region, different parts of the PBCH may be copied to distinguish the pattern. Alternatively, information corresponding to a corresponding state may be transmitted by configuring as many patterns as the number of cases in which three of the four OFDM symbols constituting the PBCH are selected and arranged in order. Alternatively, a pattern may be classified in the form of multiplying the same OFDM symbol by an orthogonal sequence.

Next, a method of transmitting information in coded bits to which separate channel coding is applied will be described.

This method is a method of transmitting additional information not included in the MIB and/or SIB1-BR in the LTE control region by applying separate coding.

For example, only 4 SIB1-BR repetition can be supported in the case of 1.4 MHz BW, and this method can be used to deliver information to inform the sMTC UE of additional repetition (if there is an additional NB). Alternatively, when notifying the eMTC terminal as an X system BW (X needs to be indicated as one of the existing LTE system bandwidth that can be interpreted by the eMTC or LTE terminal. For example, when indicated as 1.4 MHz, eMTC and LTE terminal can understand as a 1.4MHz cell that supports eMTC) and further configuring an additional BW to the sMTC, the MIB indicates only X-MHz, and the control region (to expand the system bandwidth of sMTC) in front of the MIB may be used to additionally inform the sMTC BW.

In this case, the initial access BW is X-MHz (at least the CRS needs to be transmitted within RBs supported by the X-MHz LTE system bandwidth), and in the BW viewing only the sMTC indicated through LTE control region signaling, the CRS may be omitted. In this case, sMTC sees the extended BW as the entire system BW, and SIB1-BR additional repetition can also be expected according to LTE control region signaling. However, rate-matching (for coherent combining with an NB in which a CRS exists) can follow the initial access BW as if there is a CRS.

This expanded BW need not be symmetric based on the initial access BW, and there is no need to add an RB gap between NBs. That is, the X-MHz indicated by the MIB may be used as time/frequency resources used for coexistence with LTE and eMTC terminals.

The bandwidth allocated only to sMTC can be used to expand the bandwidth of sMTC while minimizing coexistence considerations. This method can be used to transmit information necessary for coexistence with NR. The system bandwidth extension information for the purpose sMTC may be indicated using spare/reserved bits of the MIB (bits that the eMTC terminal does not understand), not the method indicated in the control region proposed above.

The sMTC UE may perform BD the PBCH extension (not necessarily PBCH repetition, but may be filled with separate coded other information) of the LTE control region before or at the same time before PBCH decoding, or decoding the PBCH in the same manner as eMTC in consideration of the terminal complexity, and then may receive the PBCH extension after checking whether PBCH extension support or presence is present through a predefined MIB field (e.g., MIB 1 spare bit).

Next, it will be described for the LTE control region indication.

In sMTC, the MPDCCH/PDSCH region (i.e., the starting point of the OFDM symbol or the number of OFDM symbols used for MPDCCH/PDSCH transmission) or the LTE control region may be more dynamically configured.

As a method of utilizing this, for example, when R2 is shared with eMTC, the startSymbolBR of SIB1-BR may be configured to the maximum value, and it is possible to dynamically configure or change a control region for an sMTC UE through the dynamic control region indication method capable of receiving only sMTC UEs. In this way, the sMTC UE can use for itself a part of the LTE control region or all except the RE required for signaling and/or RS transmission through dynamic configuration.

For example, the LTE control region information may be used the LTE PCFICH as it is, or may be repeated in the frequency domain or in OFDM symbol units in the LTE control region for coverage extension (i.e., according to CE mode/level). Alternatively, the LTE control region information may be repeated over the LTE control region of a plurality of subframes.

Regarding the above, the LTE control region information for the conventional eMTC is transmitted in a broadcast format (e.g., SIB) or is specified in the spec as a fixed value if inevitable. Here, the starting symbol value (startSymbolBR) of the MPDCCH/PDSCH allowed for eMTC is 1/2/3/4, but the starting symbol value of the MPDCCH/PDSCH allowed for sMTC may include 0 (e.g., startSymbolBR=0/1/2/3/4). This may be indicated to the eMTC UE and the sMTC UE in the SIB as follows.

For example, one of startSymbolBR=0/1/2/3/4 is notified to the sMTC UE with a separate SIB field (the separate maximum startSymbolBR that can only be understood by the sMTC terminal may be set to be smaller than the startSymbolBR indicated to the eMTC), or the sMTC UE is always recognized as startSymbolBR=0 irrespective of the SIB, or whether startSymbolBR=0 may be informed by UE-specific RRC.

Next, it will be described for the UL HARQ-ACK feedback signaling.

Conventional eMTC supports only asynchronous HARQ for UL transmission. The sMTC may support synchronous HARQ for UL transmission by transmitting the HARQ-ACK feedback signal in the LTE control region.

Here, the definition of synchronous may be more extensive than synchronous HARQ in LTE. For example, the UL HARQ-ACK feedback time point after UL transmission may be defined as a transmission opportunity form having a specific period (e.g., configured by higher layer or by UL scheduling DCI). The first UL HARQ-ACK feedback transmission opportunity may be repeated with a specific period (synchronous) starting from a certain time point (e.g., configured by higher layer or by UL scheduling DCI) from the last or first subframe of (repeated) UL transmission.

Through the UL HARQ-ACK feedback signal, the base station may perform an early UL HARQ-ACK feedback signal when the base station succeeds ‘early’ decoding at a time point when repetition of UL data repeatedly transmitted by the sMTC UE is not completed. The sMTC UE can reduce power consumption by early stopping UL transmission using an early UL HARQ-ACK feedback signal. The sMTC UE may have to monitor the UL HARQ-ACK feedback signal at the above-mentioned periodic UL HARQ-ACK feedback signal transmission opportunity during UL repetitive transmission in order to determine the UL transmission termination time point.

Next, it will be described for the DL control search space (SS) for the sMTC UE.

The LTE control region can be used for sMTC DL control channel transmission by configuring a new DL control SS in the corresponding region. For example, a USS for an sMTC UE may be configured in the LTE control region, and the corresponding USS may be allowed only to the sMTC UE, or limited to UEs configured to use the LTE control region. Alternatively, the corresponding USS can be used to support self-subframe scheduling to a high capability UE. Alternatively, it is possible to configure CSS for the sMTC UE and the sMTC UE may perform CSS monitoring in R1 and USS monitoring (LTE EPDCCH operation) in R2.

In order to transmit the control channel for the sMTC UE in the LTE control region, a new ECCE may be defined in the LTE control region. For the sMTC UE, an AL may be configured by combining the ECCE defined in the LTE control region and the ECCE in the conventional MPDCCH region. Alternatively, the CCE of the LTE control region may follow the CCE configuration of LTE.

In the method for lowering the code rate of MPDCCH/PDSCH data, the method of copying some of the MPDCCH OFDM symbols to the LTE control region to improve MPDCCH performance is proposed.

In this case, when receiving common search space (CSS) with eMTC, it is assumed that there is a CRS and the MPDCCH can be extended. When the UE-specific search space (USS) is a control channel for the sMTC UE, the presence or absence of a CRS may be selected differently according to the BL/CE DL subframe and MBSFN subframe configuration. Even in the case of extension under the assumption that there is no CRS in the above, it may be assumed that there is a CRS when repetitive transmission is configured and a duration in which the CRS is to be transmitted is included in the repetitive transmission duration.

Next, it will be described for time resources for coexistence with other systems.

All of the above proposals are methods of using the LTE control region to transmit a specific signal or channel, but there may also be a way to empty it without transmitting a signal for sMTC for coexistence with other systems (e.g., services requiring NR or low-latency). This is possible when eMTC or LTE is not supported, and sMTC terminals may be configured to expect a signal/channel from the LTE control region in a specific subframe periodically or aperiodically. That is, when coexistence with a third system is required, the LTE control region can be opportunistically used for sMTC terminals, and this can be implemented in a method of configuring whether the sMTC terminal can expect a signal/channel for each subframe in the form of signaling (e.g., bitmap).

### Fourth Embodiment: sMTC System Operation

The fourth embodiment relates to operations and controls to be considered for supporting an sMTC system.

LTE Control Region Use

The LTE control region is not used in a channel or signal in an idle mode, but can be used only in a connected mode. For example, the LTE control region can be used only when instructed to use the LTE control region with UE specific RRC in the connected mode.

The usage indication of the LTE control region may be in the form of a subframe bitmap for a subframe capable of using a kind of the LTE control region.

Alternatively, whether to use the LTE control region may be configured for each frequency. For example, when sMTC may operate over an NR frequency region and an LTE frequency region, or may operate over the RAT area or empty spectrum different from the NR frequency area used for specific purposes such as control of the first few OFDM symbol(s) of a subframe or slot, or the first OFDM symbol(s) of a subframe or a slot of a specific bandwidth part or a partial frequency region in NR are used for a specific purpose such as control, whether to use the LTE control region may be configured for each frequency.

Alternatively, the use of the LTE control channel can be applied only when a data channel is scheduled. For example, the MPDCCH transmission subframe is not used in the LTE control region, and the LTE control region may be used only in the PDSCH transmission subframe. In the case of a PDSCH transmission subframe, scheduling DCI can dynamically indicate whether to use the LTE control region and related detailed parameters (e.g., RE mapping method, channel coding related option, etc.).

In addition, related options including whether to use the LTE control region may be configured by cell-specific and/or UE-specific higher layer signaling.

In addition, it will be described for the GP (guard period) for NB retuning when using the LTE control region.

In the eMTC, in the case of Tx-to-Rx or Rx-to-Rx NB retuning, the DL subframe on the Rx side always absorbs the switching gap. The reason is that in the case of BL/CE subframe, in order to protect the LTE control region, do not transmit DL to the eMTC UE for the first L symbol (L is fixed to 3 or 4, or a higher layer is configured in a range of 1-4). Because. However, in the case of sMTC, since the LTE control region does not need to be protected, the LTE control region may be used for DL data or DL control signaling as proposed in this disclosure. Therefore, it is necessary to consider the GP for Tx-to-Rx or Rx-to-Rx NB retuning accordingly.

For the sMTC UE, or when the sMTC UE is configured to receive DL data or control signal (for example, (M)PDCCH) through the LTE control region, the location of the GP according to the data type or priority of the data type may be determined as a source NB or a destination NB.

Here, the data type may be classified into payload data and control signals downloaded from an upper layer.

For example, control signals have higher priority than data.

Therefore, for example, in A-to-B NB retuning, whether the GP is configured to A or B, if A is a control signal and B is data (transmitted in PDSCH), the GP is configured to the first OFDM symbol(s) of B (i.e. destination NB), and vice versa, the last OFDM symbol(s) of A (i.e. source NB)), and if it is equal priority, that is, if all data or all control signals, the GP is equally divided into A and B in OFDM units.

As an example of the equal division method, if the length of the GP corresponds to two OFDM symbols, one OFDM symbol is placed in both A and B to configure the GP, respectively. Alternatively, if equal division is not possible because the length of the GP is odd in OFDM symbol units, the GP is always configured to A side, that is, so that the source NB side, is one more per OFDM symbol unit than the destination NB. If both control signal monitoring and data reception are attempted in a specific subframe, the corresponding subframe is regarded as a subframe for monitoring control signals and the GP can be created. Here, a duration of the GP may be a duration in which the base station does not perform MPDCCH/PDSCH scheduling during the corresponding duration or the duration of the GP may be a duration that is allowed not to attempt reception by considering the corresponding duration as the GP depending on the capability of the terminal, even if a signal is transmitted in the corresponding duration.

In the case of Tx-to-Rx, if the last symbol in the subframe immediately preceding Rx is configured as a duration for SRS transmission, the UE considers the duration as part of the GP, and the first part of the Rx duration after Tx (GP Requested time-SRS transmission duration) can be used as a duration for the rest of the GP.

Here, when the SRS transmission is not configured for the terminal expecting Rx, or the corresponding terminal does not transmit the actual SRS and other UL signals in the configured SRS duration, the SRS duration may be regarded as a partial duration of the GP as proposed above. Alternatively, a new signal or message may be defined for the purpose of generating such the GP, and the base station may inform the terminal of this.

As another method, there is also a method in which the base station directly indicates a duration that can be used as the GP in the Rx duration. Unlike the above proposal, since a signal to be transmitted by the base station in the Rx duration can be resource mapped in a rate-matching manner, there may be an advantage in terms of code rate.

For this, the terminal may individually report the required GP duration. However, when receiving a channel that can be expected to receive simultaneously with eMTC terminals or with other sMTC terminals (for example, paging, common DCI, etc.), terminals may only assume to be the GP generated based on the eMTC's GP (which may be determined by a control region value).

The proposed methods can be applied/interpreted differently in RRC connected mode and idle mode.

The LTE control region can be used as a GP for frequency (or narrowband) retuning. In this case, like the eMTC, the UE does not perform DL reception during the LTE control region, and the base station does not perform MPDCCH/PDSCH scheduling during the corresponding period, thereby securing the GP. The enable/disable signal for using the LTE control region as a GP can be configured UE-specifically through higher layer signaling or dynamically configured through DCI, and can be automatically used as a GP in a specific subframe or slot.

The specific subframe or slot may be the first subframe or slot of the destination frequency (or narrowband) in the above description.

When applied in the same way as the LTE control region utilization method described above (the method proposed in the first to third embodiments), the GP is used only in the case of the specific subframe or slot, and for the remaining subframes or slots, the method of utilizing the (higher layer configured) LTE control region proposed in the first to third embodiments may be applied.

In order to support the LTE control region utilization method more dynamically, the method of using the LTE control region of the corresponding subframe or slot through scheduling DCI (e.g., whether it is used as one of the methods proposed in the first to third embodiments above or as a GP) can be indicated.

The number of OFDM symbols that sMTC can expect to receive in the LTE control region may vary depending on a UE. For example, the number of symbols of the available LTE control region may be different according to the frequency retuning time of UL. In this case, all of the above may be similarly applied for each UE. Meanwhile, since the first symbol in which CRS is transmitted is advantageous in terms of reception performance, sMTC terminals may expect DL transmission for all OFDM symbols in the LTE control region, and the eNB may schedule MPDCCH/PDSCH during the corresponding period. Here, the necessary retuning gap is secured as the last OFDM symbol(s) of the previous subframe or slot, and in this case, the eNB may perform rate-matching assuming the GP for the last OFDM symbol(s) of the corresponding subframe or slot, and the sMTC terminal may receive assuming rate-matching for the GP.

Method to Support in TDD

In this section, a method of supporting the sMTC system in TDD is proposed.

Use of DwPTS in TDD

Even in the case of CE mode B, the sMTC terminal can expect to receive MPDCCH in the Downlink Pilot Time Slot (DwPTS). Here, the required number of OFDM symbols may be limited to a special subframe configuration in which as many OFDM symbols are secured in DwPTS when CE mode A excludes the control region in the existing eMTC.

In the case of CE mode A, as above, when the number of OFDM symbols including all the symbols of the control region is secured as many as the number of symbols necessary for the eMTC to use DwPTS, MPDCCH reception can be expected in the corresponding DwPTS.

Even in the case of CE mode B, the sMTC terminal can expect to receive PDSCH in DwPTS. Here, the required number of OFDM symbols in this case may be limited to a special the required number of OFDM symbols may be limited to a special subframe configuration in which as many OFDM symbols are secured in DwPTS when CE mode A excludes the control region in the existing eMTC.

In the case of CE mode A, as above, when the number of OFDM symbols including all the symbols of the control region is secured as many as the number of symbols necessary for the eMTC to utilize DwPTS, PDSCH reception can be expected in the corresponding DwPTS.

In the case of sharing with eMTC in the above A/B/C/D, the use of DwPTS is interpreted in the same manner as eMTC.

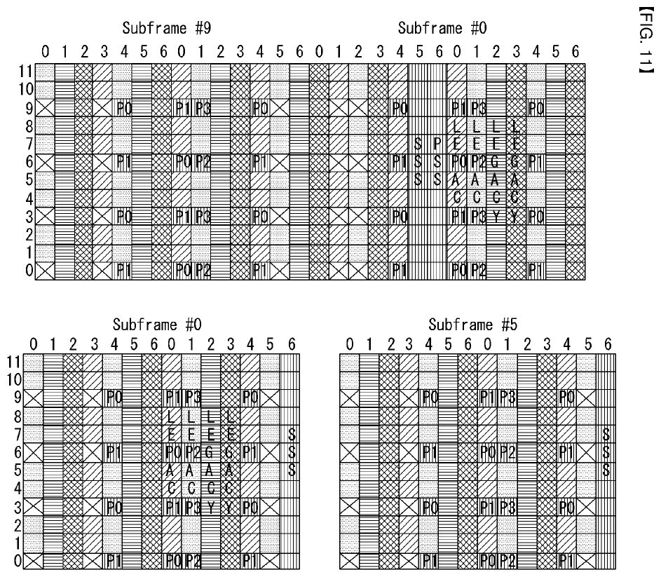

FIG. 12 is a flowchart illustrating an example of an operation method by a base station for transmitting an MPDCCH proposed in the present disclosure.

That is, FIG. 12 shows an operation method by a base station for transmitting an MTC Physical Downlink Control Channel (MPDCCH) in a wireless communication system supporting Machine Type Communication (MTC).

First, the base station performs to map an MPDCCH to resource elements (REs) (S1210).

And, the base station transmits the MPDCCH to the terminal on the REs (S1220).

The MPDCCH mapping includes copying REs used for MPDCCH in at least one symbol of a second slot of a subframe to at least one symbol of a first slot of the subframe.

Here, at least one symbol of the first slot may be a symbol corresponding to at least one symbol of the second slot.

In addition, at least one symbol of the second slot may be a symbol including a cell-specific reference signal (CRS).

In addition, at least one symbol of the first slot is included in a control region, and the control region may be an LTE control region.

In addition, the number of at least one symbol of the second slot may be determined according to the number of symbols included in the control region. For a more detailed description, refer to the previous section.

In the MPDCCH mapping, coded bits may be frequency first RE mapped in at least one symbol of the second slot, and the remaining bits of the coded bits may be frequency first RE mapped in at least one symbol of the first slot.

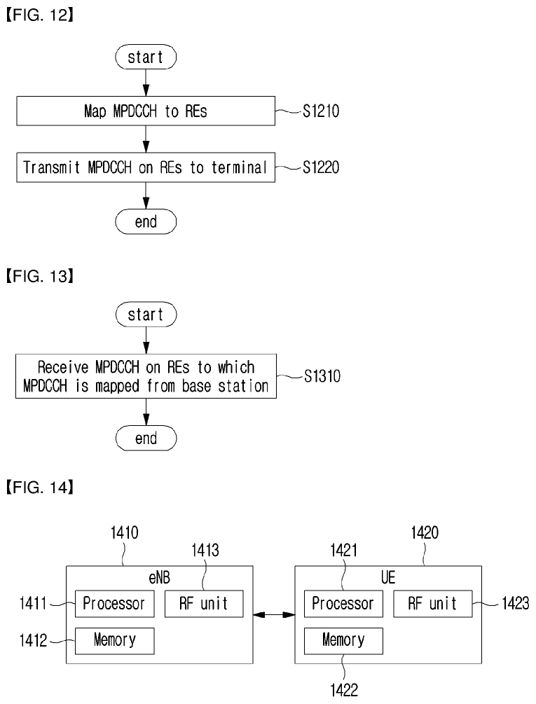

FIG. 13 is a flowchart illustrating an example of an operation method by a terminal for receiving an MPDCCH proposed in the present disclosure.

The UE receives an MPDCCH from the base station on REs to which the MPDCCH is mapped (S1310).

MPDCCH mapping includes copying REs used for the MPDCCH in at least one symbol of a second slot of a subframe to at least one symbol of a first slot of the subframe.

Here, at least one symbol of the first slot may be a symbol corresponding to at least one symbol of the second slot.

In addition, at least one symbol of the second slot may be a symbol including a cell-specific reference signal (CRS).

In addition, at least one symbol of the first slot is included in a control region, and the control region may be an LTE control region.

In addition, the number of at least one symbol of the second slot may be determined according to the number of symbols included in the control region. For a more detailed description, refer to the previous section.

In the MPDCCH mapping, coded bits may be frequency first RE mapped in at least one symbol of the second slot, and the remaining bits of the coded bits may be frequency first RE mapped in at least one symbol of the first slot.

General Apparatus to Which the Present Disclosure may be Applied

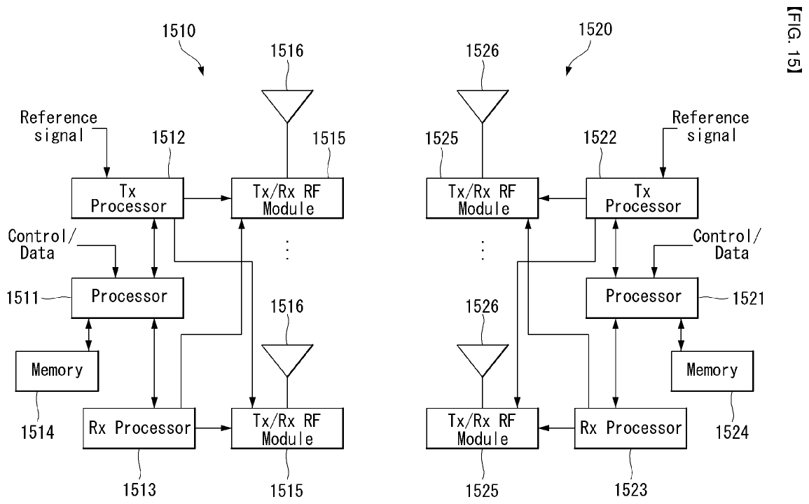

FIG. 14 illustrates a block diagram of a radio communication device to which methods suggested in the present disclosure may be applied.

In reference to FIG. 14, a radio communication system includes a base station 1410 and a plurality of terminals 1420 positioned in a region of a base station.

The base station and terminal may be represented as a radio device, respectively.

A base station 1410 includes a processor 1411, a memory 1412 and a radio frequency (RF) module 1413. A processor 1411 implements a function, a process and/or a method previously suggested in FIG. 1 to FIG. 13. Radio interface protocol layers may be implemented by a processor. A memory is connected to a processor to store a variety of information for operating a processor. A RF module is connected to a processor to transmit and/or receive a radio signal.

A terminal includes a processor 1421, a memory 1422 and a RF module 1423.

A Processor implements a function, a process and/or a method previously suggested in FIG. 1 to FIG. 13. Radio interface protocol layers may be implemented by a processor. A memory is connected to a processor to store a variety of information for operating a processor. A RF module is connected to a processor to transmit and/or receive a radio signal.

Memories 1412 and 1422 may be inside or outside processors 1411 and 1421 and may be connected to a processor in a well-known various means.

In addition, a base station and/or a terminal may have one single antenna or multiple antenna.

Antennas 1414 and 1424 function to transmit and receive radio signals.

FIG. 15 is another example of a block diagram of a radio communication device to which methods suggested in the present disclosure may be applied.

In reference to FIG. 15, a radio communication system includes a base station 1510 and a plurality of terminals 1520 positioned in a region of a base station. A base station may be represented as a transmission device and a terminal may be represented as a reception device, and vice versa. A base station and a terminal include processors 1511 and 1521, memories 1514 and 1524, one or more Tx/Rx radio frequency (RF) modules 1515 and 1525, Tx processors 1512 and 1522, Rx processors 1513 and 1523 and antennas 1516 and 1526. A processor implements the above-described function, process and/or method. In more detail, an upper layer packet from a core network is provided for a processor 1511 in a DL (a communication from a base station to a terminal). A processor implements a function of a L2 layer. In a DL, a processor provides radio resource allocation and multiplexing between a logical channel and a transmission channel for a terminal 1520 and takes charge of signaling to a terminal. A transmission (TX) processor 1512 implements a variety of signal processing functions for a L1 layer (e.g., a physical layer). A signal processing function facilitates forward error correction (FEC) in a terminal and includes coding and interleaving. An encoded and modulated symbol is partitioned into parallel streams, and each stream is mapped to an OFDM subcarrier, is multiplexed with a reference signal (RS) in a time and/or frequency domain and is combined together by using Inverse Fast Fourier Transform (IFFT) to generate a physical channel which transmits a time domain OFDMA symbol stream. An OFDM stream is spatially precoded to generate a multiple spatial stream. Each spatial stream may be provided for a different antenna 1516 in each Tx/Rx module (or a transmitter-receiver 1515). Each Tx/Rx module may modulate a RF carrier in each spatial stream for transmission. In a terminal, each Tx/Rx module (or a transmitter-receiver 1525) receives a signal through each antenna 1526 of each Tx/Rx module. Each Tx/Rx module reconstructs information modulated by a RF carrier to provide it for a reception (RX) processor 1523. A RX processor implements a variety of signal processing functions of a layer 1. A RX processor may perform a spatial processing for information to reconstruct an arbitrary spatial stream heading for a terminal. When a plurality of spatial streams head for a terminal, they may be combined into a single OFDMA symbol stream by a plurality of RX processors. A RX processor transforms an OFDMA symbol stream from a time domain to a frequency domain by using Fast Fourier Transform (FFT). A frequency domain signal includes an individual OFDMA symbol stream for each subcarrier of an OFDM signal. Symbols and a reference signal in each subcarrier are reconstructed and demodulated by determining the most probable signal arrangement points transmitted by a base station. Such soft decisions may be based on channel estimated values. Soft decisions are decoded and deinterleaved to reconstruct data and a control signal transmitted by a base station in a physical channel. The corresponding data and control signal are provided for a processor 1521.

An UL (a communication from a terminal to a base station) is processed in a base station 1510 by a method similar to that described in a terminal 1520 in relation to a function of a receiver. Each Tx/Rx module 1525 receives a signal through each antenna 1526. Each Tx/Rx module provides a RF carrier and information for a RX processor 1523. A processor 1521 may be related to a memory 1524 which stores a program code and data. A memory may be referred to as a computer readable medium.

The embodiments described so far are those of the elements and technical features being coupled in a predetermined form. So far as there is not any apparent mention, each of the elements and technical features should be considered to be selective. Each of the elements and technical features may be embodied without being coupled with other elements or technical features. In addition, it is also possible to construct the embodiments of the present disclosure by coupling a part of the elements and/or technical features. The order of operations described in the embodiments of the present disclosure may be changed. A part of elements or technical features in an embodiment may be included in another embodiment, or may be replaced by the elements and technical features that correspond to other embodiment. It is apparent to construct embodiment by combining claims that do not have explicit reference relation in the following claims, or to include the claims in a new claim set by an amendment after application.

The embodiments of the present disclosure may be implemented by various means, for example, hardware, firmware, software and the combination thereof. In the case of the hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), a processor, a controller, a micro controller, a micro processor, and the like.

In the case of the implementation by the firmware or the software, an embodiment of the present disclosure may be implemented in a form such as a module, a procedure, a function, and so on that performs the functions or operations described so far. Software codes may be stored in the memory, and driven by the processor. The memory may be located interior or exterior to the processor, and may exchange data with the processor with various known means.

It will be understood to those skilled in the art that various modifications and variations can be made without departing from the essential features of the disclosure. Therefore, the detailed description is not limited to the embodiments described above, but should be considered as examples. The scope of the present disclosure should be determined by reasonable interpretation of the attached claims, and all modification within the scope of equivalence should be included in the scope of the present disclosure.

### INDUSTRIAL APPLICABILITY

The present disclosure has been described mainly with the example applied to 3GPP LTE/LTE-A, 5G system, but may also be applied to various wireless communication systems except the 3GPP LTE/LTE-A, 5G system.

1-14. (canceled)

15. A method of receiving a Physical Downlink Shared Channel (PDSCH) in a wireless communication system, the method performed by a terminal comprising:
receiving, from a base station, downlink control information (DCI) for scheduling the PDSCH from a base station; and
receiving, from the base station, the PDSCH on resource elements (REs) based on the DCI,
wherein a control region includes at least one symbol of a first slot of a subframe,
wherein a data region includes symbols other than the control region in the subframe, and
wherein the PDSCH is mapped to REs in the control region after the PDSCH is mapped to REs in the data region.

16. The method of claim 15, wherein REs used for the PDSCH in at least one symbol of a second slot of the subframe are copied to the at least one symbol of the first slot of the subframe.

17. The method of claim 16, wherein the at least one symbol of the second slot is a symbol including a Cell-specific Reference Signal (CRS).

18. The method of claim 15, wherein transmission of the PDSCH in the control region is configured by a radio resource control (RRC) layer signaling.

19. The method of claim 15, wherein the control region is an LTE control region.

20. The method of claim 19, wherein a number of the at least one symbol of the second slot is determined according to a number of symbols included in the control region.

21. The method of claim 15, wherein the PDSCH is frequency first RE mapped in the control region after the PDSCH is frequency first RE mapped in the data region.

22. A terminal for receiving a Physical Downlink Shared Channel (PDSCH) in a wireless communication system, the terminal comprising:
a transmitter for transmitting a radio signal;
a receiver for receiving a radio signal;
at least one processor; and
at least one computer memory operably connectable to the at least one processor and storing instructions that, when executed by the at least one processor, perform operations,
the operation comprising:
receiving, from a base station, downlink control information (DCI) for scheduling the PDSCH; and
receiving, from the base station, the PDSCH on resource elements (REs) based on the DCI,
wherein a control region includes at least one symbol of a first slot of a subframe,
wherein a data region includes symbols other than the control region in the subframe, and
wherein the PDSCH is mapped to REs in the control region after the PDSCH is mapped to REs in the data region.

23. The terminal of claim 22, wherein REs used for the PDSCH in at least one symbol of a second slot of the subframe are copied to the at least one symbol of the first slot of the subframe.

24. The terminal of claim 23, wherein the at least one symbol of the second slot is a symbol including a Cell-specific Reference Signal (CRS).

25. The terminal of claim 22, wherein transmission of the PDSCH in the control region is configured by a radio resource control (RRC) layer signaling.

26. The terminal of claim 22, wherein the control region is an LTE control region.

27. The terminal of claim 26, wherein a number of the at least one symbol of the second slot is determined according to a number of symbols included in the control region.

28. The terminal of claim 22, wherein the PDSCH is frequency first RE mapped in the control region after the PDSCH is frequency first RE mapped in the date region.

29. A method of transmitting a Physical Downlink Shared Channel (PDSCH) in a wireless communication system, the method performed by a base station comprising:
mapping the PDSCH to resource elements (REs); and
transmitting, to a terminal, the PDSCH on the REs to a terminal,
wherein a control region includes at least one symbol of a first slot of a subframe,
wherein a data region includes symbols other than the control region in the subframe, and
wherein the PDSCH is mapped to REs in the control region after the PDSCH is mapped to REs in the data region.

30. The method of claim 29, wherein REs used for the PDSCH in at least one symbol of a second slot of the subframe are copied to the at least one symbol of the first slot of the subframe.

31. The method of claim 30, wherein the at least one symbol of the second slot is a symbol including a Cell-specific Reference Signal (CRS).

32. The method of claim 29, wherein transmission of the PDSCH in the control region is configured by a radio resource control (RRC) layer signaling.

33. The method of claim 29, wherein the control region is an LTE control region.

34. The method of claim 29, wherein the PDSCH is frequency first RE mapped in the control region after the PDSCH is frequency first RE mapped in the data region.
